(19) United States
(12) Patent Application Publication
(10) Pub. No.: US 2025/0110438 A1
(43) Pub. Date: Apr. 3, 2025

(54) IMAGE FORMING APPARATUS

(71) Applicant: CANON KABUSHIKI KAISHA, Tokyo (JP)

(72) Inventor: YUYA NAGATOMO, Ibaraki (JP)

(21) Appl. No.: 18/889,836

(22) Filed: Sep. 19, 2024

(30) Foreign Application Priority Data
Sep. 28, 2023 (JP) 2023-167839

(51) Int. Cl. G03G 15/00; B65H 3/48; B65H 7/16; G03G 15/02

(52) U.S. Cl. CPC G03G 15/6511; B65H 3/48; B65H 7/16; G03G 15/0266; G03G 15/5008; G03G 15/6514; G03G 15/6529; G03G 15/757; B65H 2515/805

(57) ABSTRACT

An image forming apparatus includes an image forming portion, a driving portion configured to rotationally drive the image bearing member, a sheet support portion configured to support the sheet, a sheet blowing portion configured to perform a blowing operation, a sheet feeding portion configured to perform a feeding operation, and a control portion configured to execute a mode in which, in a predetermined period after the sheet fed by the sheet feeding portion passes through a transfer position at which a toner image formed by the image forming portion is transferred to the sheet and before a succeeding sheet fed by the sheet feeding portion passes through the transfer position, the blowing operation is performed in a state where the feeding operation is stopped. The control portion is configured to control the driving portion to stop rotation of the image bearing member during the mode.

### BACKGROUND OF THE INVENTION

### Field of the Invention

The present invention relates to an image forming apparatus that forms an image on a sheet.

### Description of the Related Art

JP H04-023747 A discloses a sheet feeding apparatus including a side-face guide plate that defines a position on one side of a sheet, and a small blower that is attached to the side-face guide plate and blows air to an end surface of the sheet. US 2023/0219776 describes that an air loosening portion performs a blowing operation, and then a sheet feeding portion performs a feeding operation in a state where the blowing operation is stopped.

In the configuration of US 2023/0219776, if the rotational driving of the photosensitive drum is continued during a period in which a job of forming an image on a plurality of sheets is being executed and the feeding operation is stopped for the blowing operation, the wear amount of the photosensitive drum with respect to the cumulative number of printed sheets increases. As a result, there is a possibility that the number of printable sheets of the photosensitive drum decreases. That is, in an image forming apparatus that performs an adjustment operation during the execution of a job, it has been required to suppress a decrease in the number of printable sheets of the photosensitive member.

### SUMMARY OF THE INVENTION

The present invention provides an image forming apparatus that can suppress a decrease in a number of printable sheets of a photosensitive member in a case where a blowing operation of blowing air to sheet is performed during an execution of a job and in a state where a feeding operation of feeding a sheet is stopped.

According to an aspect of the invention, an image forming apparatus configured to form an image on a sheet includes an image forming portion including a rotatable image bearing member, a charging unit configured to charge the image bearing member, an exposing unit configured to expose the image bearing member charged by the charging unit to form an electrostatic latent image on the image bearing member, and a developing unit configured to develop the electrostatic latent image formed on the image bearing member using developer, a driving portion configured to rotationally drive the image bearing member, a sheet support portion configured to support the sheet, a sheet blowing portion configured to perform a blowing operation of blowing air to the sheet supported on the sheet support portion, a sheet feeding portion configured to perform a feeding operation of feeding the sheet supported on the sheet support portion, and a control portion configured to execute a mode in which, in a predetermined period after the sheet fed by the sheet feeding portion passes through a transfer position at which a toner image formed by the image forming portion is transferred to the sheet and before a succeeding sheet fed by the sheet feeding portion passes through the transfer position, the blowing operation is performed in a state where the feeding operation is stopped, wherein the control portion is configured to control the driving portion to stop rotation of the image bearing member during the mode.

According to another aspect of the invention, an image forming apparatus configured to form an image on a sheet includes an image forming portion including a rotatable image bearing member, a charging unit configured to charge the image bearing member, an exposing unit configured to expose the image bearing member charged by the charging unit to form an electrostatic latent image on the image bearing member, and a developing unit configured to develop the electrostatic latent image formed on the image bearing member using developer, a driving portion configured to rotationally drive the image bearing member, a sheet support portion configured to support the sheet, a sheet blowing portion configured to perform a blowing operation of blowing air to the sheet supported on the sheet support portion, a sheet feeding portion configured to perform a feeding operation of feeding the sheet supported on the sheet support portion, and a control portion configured to execute a mode in which, in a predetermined period after the sheet fed by the sheet feeding portion passes through a transfer position at which a toner image formed by the image forming portion is transferred to the sheet and before a succeeding sheet fed by the sheet feeding portion passes through the transfer position, the blowing operation is performed in a state where the feeding operation is stopped, wherein the control portion is configured to control the driving portion during the mode such that a rotational speed of the image bearing member during the mode is slower than a rotational speed of the image bearing member during a formation of the image on the sheet.

Further features of the present invention will become apparent from the following description of exemplary embodiments with reference to the attached drawings.

### BRIEF DESCRIPTION OF THE DRAWINGS

FIG. 1 is a schematic diagram of an image forming apparatus according to an embodiment.

FIG. 2 is a block diagram illustrating a control system of the image forming apparatus according to the embodiment.

FIG. 3 is a schematic diagram illustrating an extension feeder according to the embodiment.

FIG. 4 is a schematic diagram illustrating an extension feeder according to the embodiment.

FIG. 5 is a flowchart illustrating a print job control method according to the embodiment.

FIG. 6 is a diagram showing a relationship between environmental conditions and an air blowing time in Example 1.

FIG. 7 is a flowchart illustrating a print job control method according to Example 1.

FIG. 8 is a sequence chart illustrating the operation state of the image forming apparatus according to Example 1.

FIG. 9 is a flowchart illustrating a print job control method according to Example 1.

FIG. 10 is a sequence chart showing the operation state of the image forming apparatus in Example 1.

FIG. 11A is a graph illustrating a relationship between the length of an air blowing time and a reduction rate of the printable number of sheets of the photosensitive drum.

FIG. 11B is a graph illustrating a relationship between the length of an air blowing time and a reduction rate of productivity of the image forming apparatus.

FIG. 12 is a flowchart showing a print job control method in Example 2.

FIG. 13 is a sequence chart showing the operation state of an image forming apparatus in Example 2.

FIG. 14 is a flowchart showing a print job control method in Example 3.

FIG. 15 is a sequence chart showing the operation state of an image forming apparatus in Example 3.

### DESCRIPTION OF THE EMBODIMENTS

Hereinafter, embodiments according to the present disclosure will be described with reference to the drawings.

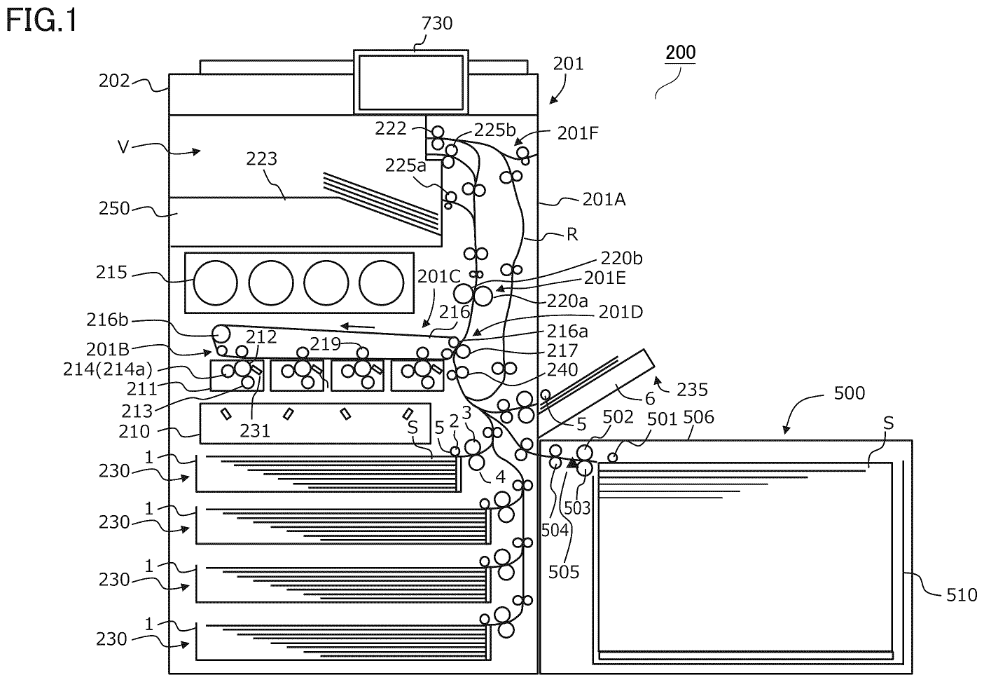

FIG. 1 is a diagram illustrating a schematic configuration of an image forming apparatus 200 according to an embodiment. The image forming apparatus 200 includes a printer 201 as an image forming apparatus body and an extension feeder 500 connected to the printer 201. The extension feeder 500 is connected to the right side of the printer 201 in FIG. 1, and is configured to feed the sheet S to the printer 201.

The image forming apparatus 200 is a system (image forming system) including a printer 201 that can be used alone as an image forming apparatus and an extension feeder 500 as an optional device connected to the printer 201. The image forming apparatus 200 may include an optional device other than the extension feeder 500. Examples of such optional devices include a sheet processing apparatus (finisher) that performs processing such as binding processing on a sheet on which an image has been formed by the printer 201, and a large-capacity stacker configured to load a large amount of printed products.

### Image Forming Apparatus

As illustrated in FIG. 1, the printer 201 includes a printer body 201A, an image reading apparatus 202, and an operation unit 730. The printer body 201A includes an image forming portion 201B as an image forming unit or means for forming an image. The image reading apparatus 202 is installed in a substantially horizontal posture above the printer body 201A. A sheet discharge space V is formed between the image reading apparatus 202 and the printer body 201A. The operation unit 730 is disposed above the printer body 201A and on the front side of the image reading apparatus 202. The operation unit 730 is a user interface of the image forming apparatus 200, and includes a display unit such as a touch panel configured to display a screen, and an input unit such as a numeric keypad and a print execution button.

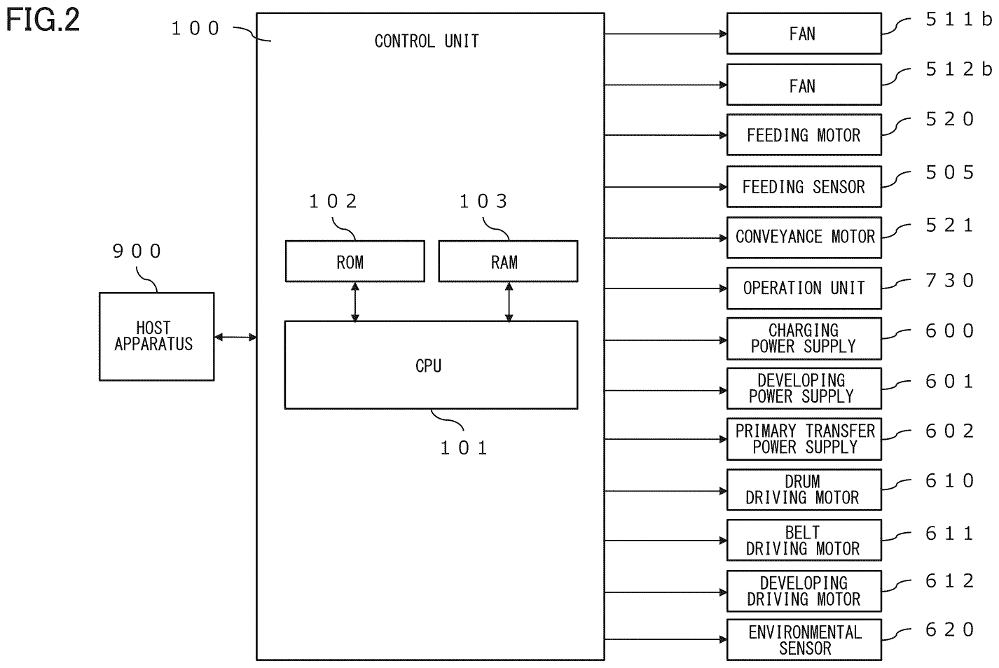

The image forming portion 201B of the present embodiment is an intermediate transfer-tandem type electrophotographic mechanism. In other words, the image forming portion 201B is a 4-drum full-color system. The image forming portion 201B includes an exposing unit 210 and four process cartridges 211Y, 211M, 211C, and 211K that form toner images of four colors of yellow (Y), magenta (M), cyan (C), and black (K). The image forming portion 201B includes an intermediate transfer unit 201C, a secondary transfer roller 217, and a fixing portion 201E. Further, the image forming portion 201B includes various motors (drum driving motor 610, belt driving motor 611, developing driving motor 612, and the like) and various high-voltage power supplies (charging power supply 600, developing power supply 601, primary transfer power supply 602, and the like) (FIG. 2).

Each of the process cartridges 211Y, 211M, 211C, and 211K has a photosensitive drum 212 as a photosensitive member (image bearing member), and is a process unit for forming a toner image on the surface of the photosensitive drum 212 by an electrophotographic process. Each of the process cartridges 211Y, 211M, 211C, and 211K is detachable from a cartridge mounting unit provided in the printer body 201A.

Each of the process cartridges 211Y, 211M, 211C, and 211K includes the photosensitive drum 212, a charger 213 as a charging unit or charging means, a developing unit 214 as a developing unit or developing means, and a cleaning blade 231 as a cleaning unit or cleaning means. The photosensitive drum 212 is a photosensitive member molded in a drum shape (cylindrical shape), and includes a photosensitive layer made of a photosensitive material such as an organic photosensitive material. The charger 213 is, for example, a charging roller that is disposed in contact with or in proximity to the surface (outer peripheral surface) of the photosensitive drum 212 and charges the surface of the photosensitive drum 212 by proximity discharge. The charger 213 is not limited to the charging roller, and may be, for example, a corona charger that charges the surface of the photosensitive drum 212 by corona discharge from a wire. The developing unit 214 includes a casing portion (developing container) that houses a developer containing toner, and a developing roller 214a (developer bearing member) that bears the developer and supplies the developer to the photosensitive drum 212.

The cleaning blade 231 is a plate-like member having appropriate elasticity and elongated in the direction of the rotation axis of the photosensitive drum 212. In the cleaning blade 231, a blade tip is in contact with the surface of the photosensitive drum 212 at a predetermined contact pressure. In the present embodiment, the cleaning blade 231 is disposed such that the direction toward the tip of the cleaning blade 231 is opposite to the rotation direction of the photosensitive drum 212 (counter direction). Note that the cleaning blade 231 may be disposed such that the direction toward the tip of the cleaning blade 231 is a direction (width direction) along the rotation direction of the photosensitive drum 212.

The printer body 201A further includes a toner cartridge 215 for supplying toner to the developing units 214 of the process cartridges 211Y, 211M, 211C, and 211K.

The intermediate transfer unit 201C is disposed above the four process cartridges 211Y to 211K. The intermediate transfer unit 201C includes an intermediate transfer belt 216 as an intermediate transfer member, a driving roller 216a, a tension roller 216b, and four primary transfer rollers 219. The intermediate transfer belt 216 is an endless belt wound around the driving roller 216a and the tension roller 216b. Each primary transfer roller 219 is disposed inside the intermediate transfer belt 216 to abut on the intermediate transfer belt 216 at a position facing corresponding one of the photosensitive drums 212. If the driving roller 216a is driven by a driving portion (not illustrated), the intermediate transfer belt 216 rotates in an arrow direction in the drawing.

The secondary transfer roller 217 is disposed in contact with the outer surface of the intermediate transfer belt 216 at a position facing the driving roller 216a. The secondary transfer roller 217 is an example of a transfer unit or transfer means (secondary transfer unit/means) that transfers an image formed on the intermediate transfer belt 216 to the sheet S. A secondary transfer portion 201D is formed as a nip portion between the intermediate transfer belt 216 and the secondary transfer roller 217.

The fixing portion 201E is disposed above the secondary transfer portion 201D. The fixing portion 201E includes a heating roller 220b as a heating member (fixing member), a pressure roller 220a as a pressure member, and a heating unit or heating means that heats the heating roller 220b. A fixing nip is formed between the heating roller 220b and the pressure roller 220a. The heating unit is, for example, a halogen lamp or a coil unit for induction heating.

The printer body 201A further includes a cassette feeding portion 230, a manual feeding portion 235, and a pair of registration rollers (hereinafter, referred to as a pair of registration rollers 240). The printer body 201A includes a first sheet discharge roller pair 225a, a second sheet discharge roller pair 225b, a double-sided reversing portion 201F, and a stacking portion 223 (sheet discharge tray).

The cassette feeding portion 230 is provided at a lower portion of the printer body 201A. In the present embodiment, the printer body 201A includes four stages of cassette feeding portions 230 arranged vertically. The cassette feeding portion 230 feeds the sheets S stacked in a cassette 1 one by one toward the image forming portion 201B by the feeding unit 5.

Each cassette feeding portion 230 includes the cassette 1 (storage unit, storage, and feeding tray) that stores a sheet S, and a feeding unit 5 as a sheet feeding portion or sheet feeding means that feeds the sheet S. In the cassette 1, a support plate (middle plate) as a sheet support portion that supports the sheet bundle is provided. The feeding unit 5 includes a pickup roller 2 that feeds the sheet S from the cassette 1, and a pair of separation rollers as a separation unit or separation means that separates the sheet S in a case where the pickup roller 2 feeds a plurality of sheets S. The pair of separation rollers includes a feed roller 3 that rotates along the sheet feeding direction, and a retard roller to which a driving force in a direction opposite to the sheet feeding direction is input via a torque limiter. The pair of rollers including the retard roller is an example of a separation unit/means, and the sheet S may be separated by, for example, a pad-shaped elastic member (friction pad) abutting on the feed roller 3. Further, the feeding unit 5 including three rollers is an example of a feeding unit/means, and for example, a separation member such as a friction pad may be in contact with a roller member that feeds the sheet S from the cassette 1.

The manual feeding portion 235 (multi-purpose feeding unit) is provided on a right side portion (side surface) of the printer body 201A. The manual feeding portion 235 includes a manual feed tray 6 as a sheet support portion (sheet support unit) that supports the sheet S, and a feeding unit 5 as a sheet feeding portion that feeds the sheet S. The configuration of the feeding unit may be the same as that of the feeding unit 5 of the cassette feeding portion 230. The manual feeding portion 235 feeds the sheet S placed by the user on the manual feed tray 6 protruding to the right side of the printer body 201A by the feeding unit 5 one by one toward the image forming portion 201B.

Note that all of the cassette feeding portion 230, the manual feeding portion 235, and the extension feeder 500 are examples of sheet feeding modules that feed the sheet S in the image forming apparatus 200. Details of the extension feeder 500 will be described later.

The first sheet discharge roller pair 225a, the second sheet discharge roller pair 225b, and a part of the double-sided reversing portion 201F are disposed above the fixing portion 201E. The first sheet discharge roller pair 225a and the second sheet discharge roller pair 225b are dischargers that discharge the sheet S on which an image is formed. The double-sided reversing portion 201F includes a reverse conveyance roller pair 222 configured to rotate in forward and reverse directions and a re-conveyance path R. In the case of an image forming operation (double-sided printing) of forming images on both sides of the sheet S, the double-sided reversing portion 201F is configured to reverse the sheet S having an image formed on the first surface by the reverse conveyance roller pair 222 and convey the sheet S toward the image forming portion 201B again via the re-conveyance path R.

### Image Forming Operation

Next, an image forming operation of the printer 201 will be described. Here, a case where an image is formed on the sheet S on the basis of image information read from a document by the image reading apparatus 202 will be described.

First, if image information of a document is read by the image reading apparatus 202, the image information is subjected to image processing and then transmitted to the exposing unit 210 of the image forming portion 201B as a video signal. In the image forming portion 201B, the photosensitive drums 212 are rotationally driven at a predetermined peripheral speed in advance in each of the process cartridges 211Y to 211K. The charger 213 uniformly charges the surface of the corresponding photosensitive drum 212 to a predetermined polarity and potential by being applied with a charging bias (charging voltage). The exposing unit 210 irradiates each photosensitive drum 212 with light on the basis of a video signal to expose the photosensitive drum 212. As a result, electrostatic latent images corresponding to monochrome images of yellow, magenta, cyan, and black are formed on the respective photosensitive drums 212. The developing unit 214 supplies a developer containing toner to the corresponding photosensitive drum 212, and develops the electrostatic latent image into a monochrome toner image. Specifically, if a developing bias (developing voltage) is applied to the developing roller 214a, the toner is transferred from the developing roller 214a to the photosensitive drum 212 by a potential difference between the surface of the photosensitive drum 212 and the developing roller 214a. As a result, the toner adheres according to the potential distribution on the surface of the photosensitive drum 212, and the electrostatic latent image is visualized as a toner image.

Thereafter, if a transfer bias (primary transfer voltage) is applied to each of the primary transfer rollers 219, a monochrome toner image is primarily transferred from each of the photosensitive drums 212 to the intermediate transfer belt 216. During primary transfer, multiple transfers are performed so that the monochrome toner images of four colors overlap each other, whereby a full-color toner image is formed on the intermediate transfer belt 216. Foreign substances such as transfer residual toner remaining on the photosensitive drums 212 without being transferred to the intermediate transfer belt 216 are scraped off by the cleaning blades 231 and removed from the surface of the photosensitive drums 212.

In parallel with the creation of the toner image by the image forming portion 201B, the sheets S are fed one by one from any of the cassette feeding portion 230, the manual feeding portion 235, and the extension feeder 500 toward the image forming portion 201B. For example, if the sheet S is fed from the cassette feeding portion 230, the sheet S is fed from the cassette 1 by the pickup roller 2, and the sheet S is conveyed toward the pair of registration rollers 240 by the feed roller 3.

The leading end of the sheet S abuts against the nip portion of the pair of registration rollers 240 in the stopped state, and deflection (loop) of the sheet S is formed. As a result, the leading end of the sheet S turns to follow the nip portion of the pair of registration rollers 240, and the relatively slight skew of the sheet S is corrected. Thereafter, driving of the pair of registration rollers 240 is started, and the sheet S is conveyed to the secondary transfer portion 201D.

In the secondary transfer portion 201D, if a transfer bias (secondary transfer voltage) is applied to the secondary transfer roller 217, an image (full-color toner image) is secondarily transferred from the intermediate transfer belt 216 to the sheet S. The sheet S that has passed through the secondary transfer portion 201D is conveyed to the fixing portion 201E and subjected to image fixing processing. The fixing portion 201E heats and pressurizes the toner on the sheet S while nipping and conveying the sheet S at the fixing nip, thereby fixing the image on the sheet S.

In the case of single-sided printing in which an image is formed only on the first surface of the sheet S, the sheet S that has passed through the fixing portion 201E is discharged to the sheet discharge space V by the first sheet discharge roller pair 225a or the second sheet discharge roller pair 225b, and is stacked on the stacking portion 223 provided at the bottom of the sheet discharge space V. In the case of duplex printing in which an image is formed on the first surface and the second surface of the sheet S, the sheet S having the image transferred to the first surface and having passed through the fixing portion 201E is sent to the reverse conveyance roller pair 222. The sheet S is reversely conveyed by the reverse conveyance roller pair 222, conveyed again to the pair of registration rollers 240 via the re-conveyance path R, and subjected to skew feeding correction. Then, in a case where the sheet S passes through the secondary transfer portion 201D and the fixing portion 201E again, an image is formed on the second surface of the sheet S. The sheet S on which the images are formed on the first surface and the second surface is discharged to the sheet discharge space V by the first sheet discharge roller pair 225a or the second sheet discharge roller pair 225b, and is stacked on the stacking portion 223.

### Extension Feeder

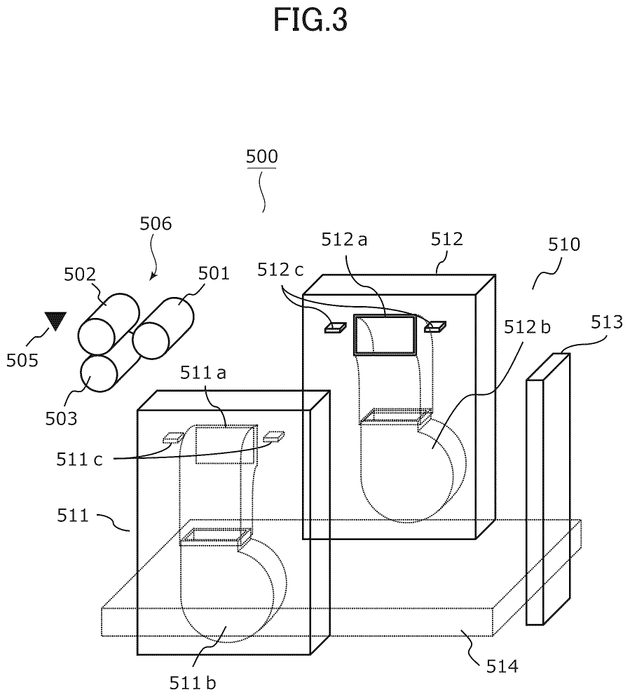

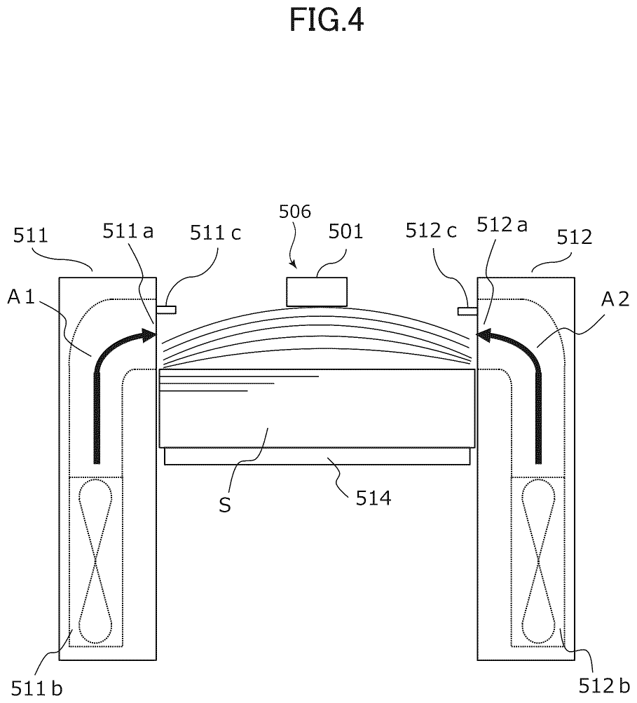

Next, details of the extension feeder 500 will be described with reference to FIGS. 1, 3, and 4. FIG. 3 is a schematic diagram illustrating a configuration of the extension feeder 500 according to the present embodiment. FIG. 4 is a schematic diagram illustrating a cross section of the extension feeder 500 according to the present embodiment cut in the sheet width direction.

The extension feeder 500 is a large-capacity sheet feeding apparatus configured to accommodate and continuously feed more sheets S than the cassette feeding portion 230 in the printer 201. As illustrated in FIG. 1, the extension feeder 500 includes a storage 510 (storage deck) as a sheet storage, a feeding unit 506 as a sheet feeding portion that feeds a sheet, a pair of drawing rollers 504, and a feeding sensor 505.

The feeding unit 506 includes a pickup roller 501 that feeds the sheet S from the storage 510, and a pair of separation rollers as a separation unit or separation means that separates the sheet S in a case where the pickup roller 501 feeds a plurality of sheets S. The pair of separation rollers includes a feed roller 502 that rotates along the sheet feeding direction, and a retard roller 503 to which a driving force in a direction opposite to the sheet feeding direction is input via a torque limiter.

The pair of drawing rollers 504 is disposed downstream of the feed roller 502 in the sheet feeding direction. The pair of drawing rollers 504 draws the sheet S from the pair of separation rollers and conveys the sheet S toward the printer 201. The feeding sensor 505 detects the sheet S at a detection position between the feed roller 502 and the pair of drawing rollers 504 in the sheet feeding direction. The feeding sensor 505 outputs a detection signal corresponding to the presence or absence of the sheet S at the detection position. The control portion of the extension feeder 500 or the printer 201 can detect the passage of the sheet S based on the detection signal of the feeding sensor 505 and monitor the feeding operation.

As illustrated in FIG. 3, the storage 510 includes a lifter plate 514, side end regulation plates 511 and 512, a trailing edge regulation plate 513, and air blowing portions 511A and 512A.

The lifter plate 514 is a sheet support portion (stacking portion) on which a plurality of sheets S (sheet bundle) is stacked and which supports the stacked sheet bundle. The lifter plate 514 can be lifted and lowered with respect to the casing of the storage 510 by a lifting mechanism (a suspension wire and a wire winding mechanism) (not illustrated). The position of the lifter plate 514 is controlled according to the stacking amount of the sheet bundle such that, for example, the uppermost sheet S has a height for being fed by the feeding unit 506.

The side end regulation plates 511 and 512 regulate positions of end portions (side ends of the sheet S) of the sheet S stacked on the lifter plate 514 in the sheet width direction orthogonal to the sheet feeding direction. The trailing edge regulation plate 513 regulates the position of the upstream end (the trailing edge of the sheet) of the sheet S in the sheet feeding direction.

The air blowing portions 511A and 512A are mechanisms (sheet blowing portion) configured to loosen the sheets S by blowing air to the end surface of the sheet bundle loaded on the lifter plate 514. The “loosening” of the sheet S means that the adhesion between the overlapping sheets is weakened so that the sheet S is easily separated (double feeding is less likely to occur) at the time of feeding by the feeding unit 506.

As illustrated in FIGS. 3 and 4, the air blowing portions 511A and 512A of the present embodiment are incorporated in the side end regulation plates 511 and 512, respectively.

The air blowing portion 511A includes a fan 511b and a blowing nozzle 511a. The fan 511b is a unit in which a rotating blade that generates an air flow and a motor that rotates the rotating blade are integrated. The blowing nozzle 511a is formed to guide the air from the fan 511b and blow the air to a side end of the sheet bundle on the lifter plate 514. The blowing nozzle 511a is open at a regulating surface (surface facing the side end of the sheet bundle) of the side end regulation plate 511.

Similarly, the air blowing portion 512A includes a fan 512b and a blowing nozzle 512a. The fan 512b is a unit in which a rotating blade that generates an air flow and a fan motor that rotates the rotating blade are integrated. The blowing nozzle 512a is formed to guide the air from the fan 512b and blow the air to another side end of the sheet bundle on the lifter plate 514. The blowing nozzle 512a is open at a regulating surface (surface facing the side end of the sheet bundle) of the side end regulation plate 512.

In addition, the side end regulation plates 511 and 512 are provided with holding plates 511c and 512c for restricting the sheet S blown with air from floating and climbing over the side end regulation plates 511 and 512 in the vicinity of the opening portions of the blowing nozzles 511a and 512a.

The fans 511b and 512b may be sirocco fans or propeller fans (axial flow fans), for example. The air blowing portions 511A and 512A may be disposed as separate units not incorporated in the side end regulation plates 511 and 512.

### Control System of Image Forming System

Next, a configuration of a control system in the image forming apparatus 200 will be described with reference to FIG. 2. FIG. 2 is a block diagram illustrating a control system of the image forming system according to the present embodiment.

A control portion 100 according to the present embodiment is provided in, for example, the printer 201. The control portion 100 is a control circuit including a CPU 101 that executes a program used for controlling the image forming apparatus, and a ROM 102 and a RAM 103 as storage units that store the program and data used for controlling the image forming apparatus. The control portion 100 is a controller or control means that controls the operation of the entire image forming apparatus 200 including the extension feeder 500. The image forming apparatus 200 may include a sub-control portion mounted on the extension feeder 500 in order to control each unit of the extension feeder 500 based on a command from the control portion 100.

The control portion 100 is connected to the host apparatus and the operation unit 730, and performs signal processing, sequence control, and the like to various process devices while exchanging information with the host apparatus 900 and the operation unit. Note that the host apparatus 900 is an external device such as a personal computer, an image scanner, or a facsimile.

In addition, the control portion 100 is electrically connected to the fans 511b and 512b, the feeding sensor 505, various motors (520, 521, 610, 611, 612), various high-voltage power supplies (600, 601, 602), and the environmental sensor 620 described above.

The feeding motor 520 is a drive source that drives the feeding unit 506. The conveyance motor 521 is a drive source that drives the pair of drawing rollers 504. The charging power supply 600 is a circuit that generates a charging voltage to be applied to the charger 213 (FIG. 1). The developing power supply 601 is a circuit that generates a developing voltage to be applied to the developing roller 214a (FIG. 1). The primary transfer power supply 602 is a circuit that generates a primary transfer voltage to be applied to each primary transfer roller 219 (FIG. 1). The drum driving motor 610 is a drive source or driving portion that rotationally drives each photosensitive drum 212. The belt driving motor 611 is a driving source that rotationally drives a driving roller 216a (FIG. 1) that drives the intermediate transfer belt 216. The developing driving motor 612 is a drive source that rotationally drives the developing roller 214a (FIG. 1). The environmental sensor 620 is an example of an environment detection portion or environment detection means that detects an environmental condition of the environment in which the image forming apparatus 200 is installed, and detects, for example, the temperature and humidity of the air taken into the casing of the image forming apparatus 200.

During the execution of the image forming operation, the drum driving motor 610 and the belt driving motor 611 rotationally drive each photosensitive drum 212 intermediate transfer belt 216 at a predetermined rotational speed (peripheral speed). The predetermined rotational speed is the length of the toner image created by the image forming portion 201B per unit time in the sub-scanning direction, and is referred to as a process speed.

### Operation During Air Blowing

Next, a state of the sheet S in a case where air is blown to the sheet bundle by the air blowing portions 511A and 512A will be described with reference to FIG. 4. FIG. 4 illustrates a state where the air blowing portions 511A and 512A perform an operation of blowing air to the sheet bundle (hereinafter, it is referred to as “air blowing operation”) in the extension feeder 500 according to the present embodiment.

As illustrated in FIG. 4, the air sent from the fans 511b and 512b of the air blowing portions 511A and 512A flows along the blowing nozzles 511a and 512a as indicated by arrows A1 and A2, and is blown to the side surface of the sheet bundle. Then, air enters a gap between several sheets to several tens of sheets located above the sheet bundle, and the sheet S floats. The holding plates 511c and 512c suppress the excessive floating of the sheet S.

By floating the sheet S by air to reduce the adhesive force between the sheets (loosening the sheet bundle), feeding of the sheet S becomes easier. For example, in the case of a sheet S having a smooth surface property such as coated paper, since the adhesion force between the sheets is strong, there is a possibility that the feeding by the pickup roller 501 is not normally performed. Specifically, even if the pickup roller 501 applies a conveying force to the uppermost sheet S, the uppermost sheet S may not move in close contact with the lower sheet S. Since the adhesion force between the sheets is reduced by loosening the sheet bundle by blowing air, the pickup roller 501 easily feeds the uppermost sheet S.

Hereinafter, driving the fans 511b and 512b to blow air to the sheet bundle is referred to as an “air blowing operation” or an air loosening operation. The air blowing operation is an example of an adjustment operation for adjusting a condition related to sheet feeding. The air blowing operation of the present embodiment is performed in order to weaken (reduce) the adhesive force between the sheets as a condition regarding sheet feeding to an extent that stable feeding by the feeding unit 506 becomes possible

The air loosening portions 511A and 512A described in the present embodiment are an example of an air loosening mechanism that loosens the sheets using air, and an air loosening mechanism having another configuration may be used. For example, in place of or in addition to the air blowing portions 511A and 512A that blow air to the side ends (end portions in the sheet width direction) of the sheet bundle, an air loosening mechanism that blows air to the tip end (downstream end in the sheet feeding direction) of the sheet bundle may be used.

### Basic Flow of Print Job

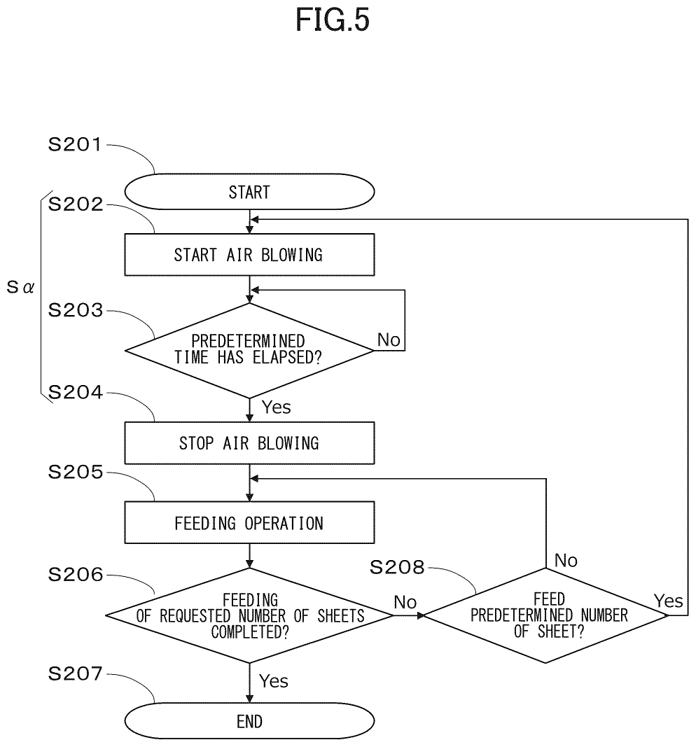

Next, a basic flow of the print job according to the present embodiment will be described with reference to FIG. 5. FIG. 5 is a flowchart illustrating an example of control related to the control of a print job in a case where the sheet S is fed from the extension feeder 500. The control content illustrated in FIG. 5 is a basis of control in each example described below.

If a print job (also simply referred to as a “job”) is input, the control portion 100 starts the following processing (S201). The print job or the image forming job is a series of tasks for forming an image on each sheet S while conveying the sheet S one by one in the image forming apparatus and outputting a product. It is assumed that the number of sheets S on which an image is formed in a print job (the number of requested sheets) is designated in advance by the user at the time of input of the print job through an operation of the operation unit 730 (FIG. 1) or a screen operation in the host device. The print job includes the above-described image forming operation, a preparation operation before starting the image forming operation, and a post-processing operation after finishing the image forming operation. The image forming operation includes a feeding operation in which the sheet feeding portion feeds one sheet S, and an operation in which the image forming portion 201B forms an image on the sheet S. As described below, the air blowing operation may be performed as part of the preparation operation before the image forming operation for the first sheet of the print job is started, or may be performed after the image forming operation for the first sheet is started.

If the execution of the print job is started, the control portion 100 executes the air blowing operation (Sα). Specifically, in the extension feeder 500, the air blowing operation is started if the fans 511b and 512b of the air blowing portions 511A and 512A are started to be driven based on a command from the control portion 100 (S202). If a predetermined time has elapsed from the start of driving of the fans 511b and 512b (Yes in S203), the driving of the fans 511b and 512b is stopped (S204), and the air blowing operation ends. By executing the air blowing operation, the sheet bundle is loosened. That is, several to several tens of sheets S located above the sheet bundle on the lifter plate 514 float up, and the adhesion force between the sheets is reduced.

The predetermined time is the length of time (hereinafter, referred to as an air blowing time) during which the air is blown to the sheet bundle by the air blowing operation. The air blowing time is the time length of the air blowing operation which is an example of the adjustment operation. The air blowing time in the present embodiment is a time length from the start of driving of the fans 511b and 511b (start of energization of the fan motors) to the stop of driving of the fans 511b and 512b (interruption of energization of the fan motors). Since the fans 511b and 512b are started to be driven from the rotation stop state, it is desirable that the time until the rotational speed (rotational speed) of the fans 511b and 512 reaches the desired rotational speed and the time until the floating of the sheet S is stabilized be considered as the air blowing time. The predetermined time is set to 10 seconds, for example. The predetermined time may be set to a different value according to the material (in particular, whether or not the material has high smoothness such as coated paper) and/or the size of the sheet S.

After the air blowing operation, the feeding operation is executed (S205). The feeding operation is a series of operations in which one sheet S is fed toward the image forming portion 201B by the feeding unit 506 as a sheet feeding portion. In the present embodiment, a series of operations from the start of driving of the feeding unit 506 by the feeding motor 520 in a state where the pickup roller 501 is in contact with the uppermost sheet S until the feeding sensor 505 detects the trailing edge of the sheet S is referred to as a “feeding operation”.

Specifically, in the extension feeder 500, the feeding unit 506 is driven by the feeding motor 520 in a state where the pickup roller 501 abuts on the topmost sheet S based on the start command (S205) of the feeding operation from the control portion 100. As a result, the sheet S is fed out from the storage 510 by the pickup roller 501, and the sheet S is separated by the feed roller 502 and the retard roller 503. The sheet S having passed through the separation nip between the feed roller 502 and the retard roller 503 is further conveyed by a pair of drawing rollers 504 driven by a conveyance motor 521 and delivered to the printer body 201A. Further, in the process of conveying the sheet S from the separation nip to the pair of drawing rollers 504, the leading end and the trailing edge of the sheet S are detected by the feeding sensor 505.

The feeding operation is repeated for each sheet S from the start of the print job until the number of sheets S fed by the feeding operation (S205) (hereinafter, the number of sheets having been fed after the start of the job is referred to as the number of fed sheets after the start of the job) reaches the requested number of sheets of the print job (that is, while S206 is No). If the number of sheets S fed from the extension feeder 500 reaches the requested number of sheets in the print job (Yes in S206), the control portion 100 ends the processing (S207).

In the present embodiment, the air blowing operation (Sα) is not executed while the feeding operation (S205) is executed. This is to reduce the possibility that skew feeding of the sheet S occurs due to the simultaneous execution of the feeding operation and the air blowing operation. Specifically, if the sheet S floats due to air, the sheet S may be bent, and the side end of the sheet S may be separated from the side end regulation plates 511 and 512. In this case, the skew feeding suppression effect of the sheet S by the side end regulation plates 511 and 512 is lowered, and as a result, the skew feeding may occur in the sheet S. If the skew feeding amount of the fed sheet S (the inclination of the leading end of the sheet with respect to the sheet width direction) is large, the skew feeding cannot be sufficiently corrected by the skew feeding correction using the pair of registration rollers 240, and the inclination of the image may occur. Therefore, in the present embodiment, the air blowing operation is not executed while the feeding operation is executed.

While the feeding operation (S205) is repeatedly executed, the sheet S floated by the air blowing operation (Sα) is lowered by gravity, and the air between the sheets gradually escapes. That is, the sheet bundle gradually returns to the state before the air blowing operation is executed (the state in which the adhesion force between the sheets is strong). Further, if the number of sheets in the sheet bundle stacked on the lifter plate 514 is large, it is difficult to loosen all the sheets S in the sheet bundle in one air blowing operation.

Therefore, in the present embodiment, every time the number of sheets S fed by the feeding operation (S205) from the start of the print job (i.e., the number of fed sheets after the start of the job) increases by a predetermined number, the feeding operation is temporarily stopped and the air blowing operation (Sα) is executed. That is, before the number of fed sheets after the start of the job reaches the requested number of sheets of the print job (No in S206), the control portion 100 executes the air blowing operation if the number of fed sheets after the start of the job has increased by a predetermined number from the end of the previous air blowing operation (Yes in S208). The control portion 100 does not execute the air blowing operation until the number of fed sheets after the start of the job increases by a predetermined number from the previous air blowing operation (No in S208).

The “predetermined number of sheets” is set as the number of sheets S that can be loosened by one air blowing operation. In other words, the “predetermined number of sheets” represents the number of sheets S that can be fed without executing the air blowing operation again after executing the air blowing operation.

The predetermined number of sheets is set to, for example, 10 sheets. In this case, if the requested number of sheets of the print job is 10 sheets or less, after the air blowing operation (Sα) is executed before the first sheet S is fed, 10 sheets S are fed without executing the air blowing operation again. On the other hand, if the requested number of sheets of the print job is 50, after the air blowing operation (Sα) is executed before the first sheet Sis fed, the air blowing operation (Sα) is executed once every time the number of fed sheets after the start of the job increases by 10 sheets. Therefore, the air blowing operation (Sα) is executed five times in total until the print job is completed.

If the feeding operation is repeated without executing the air blowing operation (Sα) (No in S208), the feeding operation of the next sheet is started at a predetermined interval (sheet interval) after the completion of the preceding sheet feeding operation. If the air blowing operation (Sα) is executed (Yes in S208), the time from the completion of the feeding operation of the preceding sheet to the start of the feeding operation of the next sheet (sheet fed first after the air blowing operation) may be longer than the predetermined interval.

As described above, in the present embodiment, if the print job of the requested number of sheets larger than the predetermined number of sheets is executed, the feeding operation is temporarily stopped and the air blowing operation (Sα) is executed, and the feeding operation is resumed after the air blowing operation (Sα) is executed. In other words, in a case of executing a job of forming an image on a number of sheets larger than a predetermined number of sheets, the control portion is configured to stop the feeding operation after the predetermined number of sheets are fed by the sheet feeding portion, execute an adjustment operation for adjusting a condition related to feeding of sheets, and restart the feeding operation after the execution of the adjustment operation.

Meanwhile, during the execution of the print job, the image forming portion 201B is normally continuously driven. However, if the image forming portion 201B is continuously driven in a case where the feeding operation is temporarily stopped and the air blowing operation is executed, the wear amounts of the photosensitive drums 212 with respect to the cumulative number of printed sheets of the image forming apparatus 200 may increase.

That is, since the sheet S is not fed to the image forming portion 201B while the feeding operation is interrupted to perform the air blowing operation, the creation of the toner image to be formed on the sheet S in the image forming portion 201B is also stopped. As described above, since the time during which the image forming portion 201B is driven becomes long even though the toner image is not generated, the wear amount of the photosensitive drum 212 with respect to the cumulative number of printed sheets increases. That is, the wear amount of the photosensitive drum 212 with respect to the cumulative number of printed sheets of the image forming apparatus 200 increases compared to a case where the air blowing operation is not executed or a case where the air blowing operation is executed simultaneously with the feeding operation without stopping the feeding operation. As a result, the printable number of sheets (the cumulative number of printed sheets that require cartridge replacement) on the photosensitive drum 212 may be reduced compared to a case where the air blowing operation is not executed. In addition, if the photosensitive drum 212 is a part of the process cartridges 211Y to 211K, the number of printable sheets (the cumulative number of printed sheets that require cartridge replacement) of the process cartridges may be smaller than that in a case where the air blowing operation is not executed.

The wear speed of the photosensitive drum 212 changes due to a plurality of factors. For example, the photosensitive drum 212 is worn by being rubbed against the cleaning blade 231 (FIG. 1). If the charging voltage is applied to the charger 213, the surface of the photosensitive drum 212 is deteriorated by the discharge between the charger 213 and the photosensitive drum 212, and the wear of the photosensitive drum 212 is promoted. Although the cause of wear of the photosensitive drum 212 varies depending on the specific configuration of the image forming portion 201B, basically, wear of the photosensitive drum 212 progresses during a period in which the image forming portion 201B is driven. Even in the configuration in which the cleaning blade 231 is not provided, the photosensitive drum 212 may be worn by rubbing with the intermediate transfer belt 216 or the like.

Therefore, in each example of the present embodiment described below, if the air blowing operation is executed during the execution of the print job, processing such as temporarily stopping the driving of the image forming portion 201B is executed. As a result, it is possible to suppress the progress of wear of the photosensitive drum 212 while the feeding operation is interrupted to execute the air blowing operation.

### Example 1

Control of the image forming apparatus 200 according to Example 1 will be described. In Example 1, the operation of the image forming portion 201B is temporarily stopped in a case where the feeding operation is temporarily stopped and the air blowing operation is executed during the execution of the print job. In addition, the execution propriety and the execution time (air blowing time) of the air blowing operation are changed according to the type of the sheet S to be fed and the environmental conditions of the installation place of the image forming apparatus 200.

First, whether to execute the air blowing operation according to the type of the sheet S will be described. It is assumed that the type of the sheet S is set in advance by the user by a screen operation or the like of the operation unit 730 at the time of input of a print job.

In Example 1, if the type of the sheet S used in the print job is a sheet having a weak adhesion force between sheets, the air blowing operation is not executed. The sheet having a weak adhesion force between sheets is, for example, plain paper. By not executing the air blowing operation on a sheet having a weak adhesion force between sheets, that is, a sheet that is relatively easily separated without executing the air blowing operation, productivity can be improved. On the other hand, in Example 1, if the type of the sheet S used in the print job is a sheet having a strong adhesion force between sheets, the air blowing operation is executed. The type having strong adhesion between sheets is, for example, coated paper and water-resistant paper.

Next, the setting of the air blowing time according to the environmental conditions will be described. In Example 1, the control portion changes the time length of the air blowing operation according to an environmental condition detected by the environment detection portion. In Example 1, the air blowing time is determined based on the temperature and humidity detected by the environmental sensor 620. That is, the environmental conditions in Example 1 are a combination of temperature and humidity (hereinafter, collectively referred to as temperature and humidity information). As the environmental conditions, only one of temperature and humidity may be used. The humidity may be either relative humidity or absolute humidity (absolute moisture content).

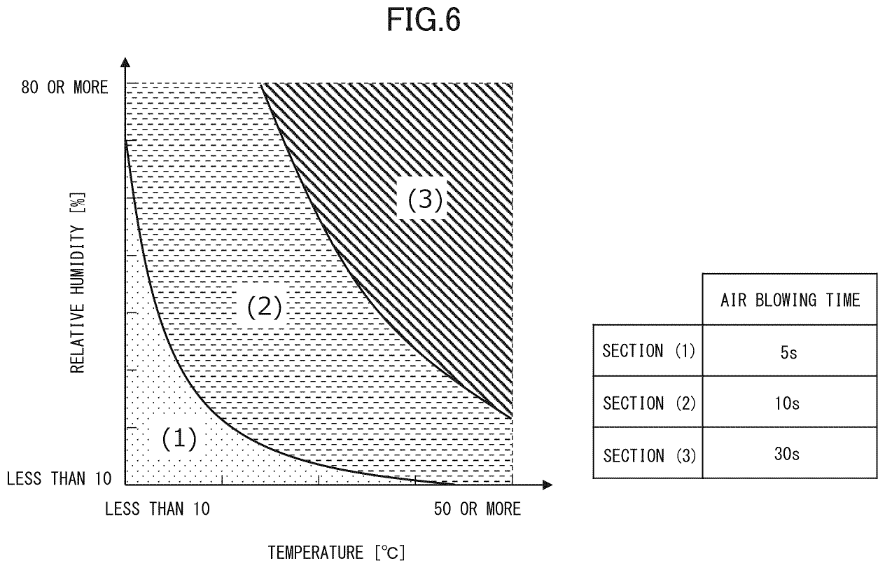

FIG. 6 shows an example of setting criteria of the air blowing time according to the temperature and humidity information. In Example 1, as shown in FIG. 6, the environmental conditions are divided into three sections (1) to (3) according to the values of temperature and humidity, and different air blowing times are set between sections (1) to (3). Section (3) is an environment where the amount of moisture in the atmosphere is large, and adhesion between sheets tends to be strong due to moisture. Therefore, if the temperature and humidity information corresponds to section (3), it is preferable to set the air blowing time to be long and to more reliably loosen the sheet bundle. On the other hand, section (1) is an environment in which the amount of moisture in the atmosphere is small, and the adhesion force between the sheets is less likely to be strong. Therefore, if the temperature and humidity information corresponds to section (1), it is preferable to set the air blowing time to be short to enhance the productivity of the image forming apparatus 200. Section (2) is an environment in which the amount of moisture in the atmosphere is medium. Therefore, if the temperature and humidity information corresponds to section (2), it is preferable to set the air blowing time to a value between section (1) and section (3) in order to balance separability and productivity.

In Example 1, the air blowing time is set to 5 seconds if the temperature and humidity information corresponds to section (1), the air blowing time is set to 10 seconds if the temperature and humidity information corresponds to section (2), and the air blowing time is set to 30 seconds if the temperature and humidity information corresponds to section (3).

The above is merely an example, and the number of divisions of environmental conditions, boundary positions, and the like can be appropriately changed. Further, for example, the air blowing operation may not be executed in an environment where the amount of moisture in the atmosphere is small.

### Print Job Control Method in Example 1

If a print job is input, the control portion 100 starts the following processing (S301). If the execution of the print job is started, the control portion 100 determines the air blowing time based on the temperature and humidity information and executes the air blowing operation (Sα). Specifically, in the extension feeder 500, the air blowing operation is started if the fans 511b and 512b of the air blowing portions 511A and 512A are started to be driven based on a command from the control portion 100 (S302). If a predetermined time has elapsed from the start of driving of the fans 511b and 512b (Yes in S303), the driving of the fans 511b and 512b is stopped (S304), and the air blowing operation ends. The predetermined time in S303 is an air blowing time determined based on the temperature and humidity information. By executing the air blowing operation, the sheet bundle is loosened.

After the air blowing operation, the control portion 100 starts the operation of the image forming portion 201B (S305). In the present embodiment, the “operation of the image forming portion 201B” refers to rotating the photosensitive drums 212 and the intermediate transfer belt 216 at a process speed and applying a charging voltage, a developing voltage, and a primary transfer voltage with a voltage value at the time of image formation. In other words, in the present embodiment, the “operation of the image forming portion 201B” means an operation state in which various motors and various high-voltage power supplies are started up to a predetermined rotational speed or output voltage, and a toner image can be created if exposure by the exposing unit 210 is started on the basis of a video signal.

Specifically, the control portion 100 starts up various motors (drum driving motor 610, belt driving motor 611, and developing driving motor 612) and various high-voltage power supplies (charging power supply 600, developing power supply 601, and primary transfer power supply 602). If the start-up of each element of the image forming portion 201B is completed, the control portion 100 causes one sheet S to be fed by the feeding operation (S306). Thereafter, an image is formed on the fed sheet S by the image forming portion 201B.

The control portion 100 repeatedly executes the feeding operation (S306) until the number of fed sheets after the start of the job reaches the number of requested sheets of the print job (that is, while S307 is No). If the number of fed sheets after the start of the job reaches the requested number of sheets of the print job (Yes in S306), the control portion 100 ends the processing (S314).

While repeatedly executing the feeding operation (S306), the control portion 100 temporarily stops the feeding operation and executes the air blowing operation (Sα) every time the number of fed sheets after the start of the job increases by a predetermined number. That is, before the number of fed sheets after the start of the job reaches the requested number of sheets of the print job (No in S307), the control portion 100 executes the air blowing operation if the number of fed sheets after the start of the job has increased by a predetermined number from the end of the previous air blowing operation (Yes in S308). The control portion 100 does not execute the air blowing operation until the number of fed sheets after the start of the job increases by a predetermined number from the previous air blowing operation (No in S308). The predetermined number of sheets is, for example, 10, but it may be set to a different value depending on the type of the sheet S.

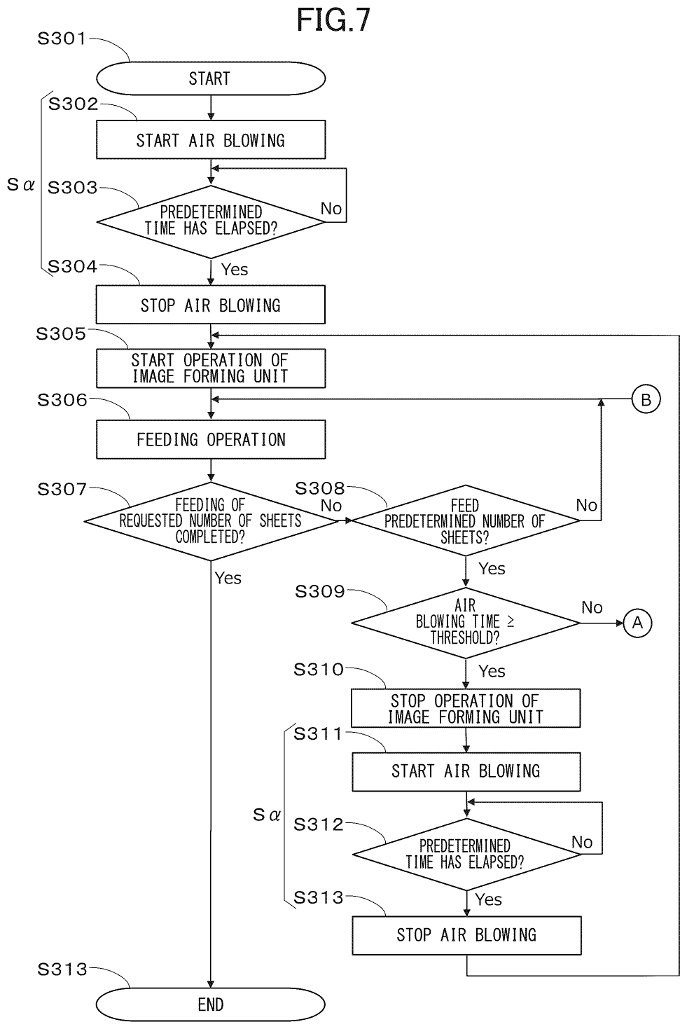

The control contents in the case of executing the air blowing operation in the middle of the print job instead of the air blowing operation (S302 to S304) at the start of the print job are different depending on the length of the air blowing time determined based on the temperature and humidity information. The middle of the print job is a period after at least one sheet S is fed after the print job is started. That is, the process in the case of Yes in S308 in FIG. 7 branches depending on the length of the air blowing time.

In a case where the air blowing operation is executed in the middle of the print job, if the air blowing time is long (Yes in S309), the procedures of S310 to S313 in FIG. 7 are executed. Specifically, if the value of the air blowing time is greater than or equal to a predetermined threshold, it is determined that the air blowing time is long. The threshold is, for example, 10 seconds. In this case, if the temperature and humidity information correspond to section (2) (air blowing time is 10 seconds) or section (3) (air blowing time is 30 seconds), it is determined that the air blowing time is long.

That is, if the air blowing time is long, the control portion 100 stops the operation of the image forming portion 201B (S310), and then executes the air blowing operation (Sα). Specifically, the control portion 100 stops various motors (drum driving motor 610, belt driving motor 611, and developing driving motor 612), various high-voltage power supplies (charging power supply 600, developing power supply 601, and primary transfer power supply 602), and the exposing unit 210 in a predetermined order. In the extension feeder 500, the driving of the fans 511b and 512b of the air blowing portions 511A and 512A is started based on the command from the control portion 100 (S311), so that the air blowing operation is started. If a predetermined time has elapsed from the start of driving of the fans 511b and 512b (Yes in S312), the driving of the fans 511b and 512b is stopped (S313), and the air blowing operation ends. The predetermined time in S312 is an air blowing time determined based on the temperature and humidity information. By executing the air blowing operation, the sheet bundle is loosened again.

If the air blowing operation is ended, the control portion 100 restarts the operation of the image forming portion 201B (S305). That is, the control portion 100 starts up various motors (drum driving motor 610, belt driving motor 611, and developing driving motor 612), various high-voltage power supplies (charging power supply 600, developing power supply 601, and primary transfer power supply 602), and the exposing unit 210. If the start-up of each element of the image forming portion 201B is completed, the control portion 100 restarts the feeding operation (S306). The processing after S306 is the same as that described above.

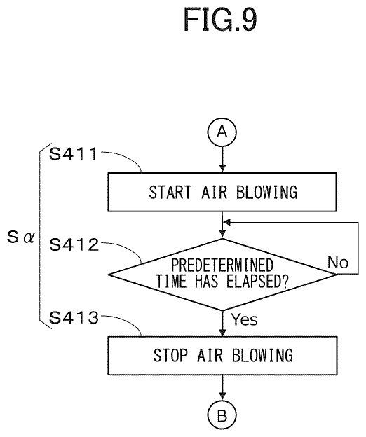

On the other hand, in a case where the air blowing operation is executed in the middle of the print job, if the air blowing time is short (No in S309), the procedures of S411 to S413 in FIG. 9 are executed. In Example 1, if the value of the air blowing time is less than a predetermined threshold, it is determined that the air blowing time is short. The threshold is, for example, 10 seconds. In this case, if the temperature and humidity information correspond to section (1) (air blowing time is 5 seconds), it is determined that the air blowing time is short.

That is, if the air blowing time is short, the control portion 100 executes the air blowing operation (Sα) without stopping the operation of the image forming portion 201B. Specifically, the control portion 100 executes the air blowing operation (Sα) while operating various motors (drum driving motor 610, belt driving motor 611, and developing driving motor 612) and various high-voltage power supplies (charging power supply 600, developing power supply 601, and primary transfer power supply 602). In the extension feeder 500, the driving of the fans 511b and 512b of the air blowing portions 511A and 512A is started based on the command from the control portion 100 (S411), so that the air blowing operation is started. If a predetermined time has elapsed from the start of driving of the fans 511b and 512b (Yes in S412), the driving of the fans 511b and 512b is stopped (S413), and the air blowing operation ends. The predetermined time in S412 is an air blowing time determined based on the temperature and humidity information. By executing the air blowing operation, the sheet bundle is loosened again.

If the air blowing operation is ended, the control portion 100 restarts the feeding operation (S306 in FIG. 7). That is, unlike the case where the air blowing time is long (S310 to S313), since the operation of the image forming portion 201B is not stopped, the control portion 100 can immediately restart the feeding operation after the end of the air blowing operation. The processing after S306 is the same as that described above.

### Operation State of Image Forming Portion

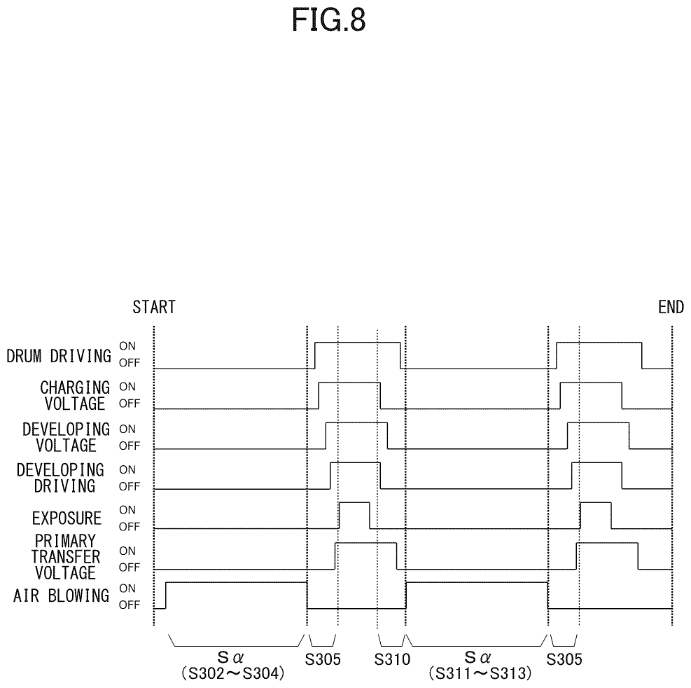

An operation state of the image forming portion 201B in a case where the air blowing time is long will be described with reference to the sequence chart of FIG. 8 while referring to the flow of FIG. 7.

If the execution of the print job is started (S301), the air blowing operation (Sα, S302 to S304) is executed at a predetermined air blowing time. After the air blowing operation is performed, the operation of the image forming portion 201B is started (S305). First, the drum driving motor 610 is started (OFF→ON), and after the drum driving motor 610 is started (that is, after the rotational speeds of the photosensitive drums 212 are stabilized at the process speed), various high-voltage power supplies and the developing driving motor 612 are sequentially started (OFF→ON). Specifically, the application of a voltage or driving of the motor is started in the order of the charging power supply 600, the developing power supply 601, the developing driving motor 612, and the primary transfer power supply 602. After the output voltages of the various high-voltage power supplies and the rotational speed of the developing driving motor 612 are stabilized, exposure by the exposing unit 210 is started. Note that the ON/OFF of the belt driving motor 611 is synchronized with the ON/OFF of the drum driving motor 610. On the other hand, if the driving of the feeding motor 520 is started (OFF→ON) after the operation of the image forming portion 201B is started, the feeding operation is started, and the sheets S are fed one by one (S306). The image forming portion 201B forms an image on the fed sheet S.

Note that the start timing of the feeding operation (the start of driving of the feeding motor 520) may be before or after the start timing of the exposure by the exposing unit 210. Before and after the start timing of the feeding operation and the start timing of the exposure also vary depending on the magnitude relationship between the length of the sheet conveyance path from the feeding unit 506 to the secondary transfer portion 201D and the path length from the exposure position in the image forming portion 201B to the secondary transfer portion 201D. For example, if the former length is longer than the latter path length, the exposure by the exposing unit 210 may be started after the start of the feeding operation. The path length from the exposure position to the secondary transfer portion 201D is the sum of the outer peripheral length of a photosensitive drum 212 from the exposure position to the corresponding primary transfer portion and the outer peripheral length of the intermediate transfer belt 216 from the primary transfer portion to the secondary transfer portion 201D.

If the predetermined number of sheets S counted from the start of the print job is fed and the exposure operation for forming an image on the sheets S is completed, the operations of the various high-voltage power sources and the various motors are sequentially stopped (S310). If the predetermined number of last sheets S are fed, the feeding motor 520 is stopped to execute the air blowing operation.

Then, in a state where the image forming portion 201B and the feeding motor 520 are stopped, the air blowing operation is executed at a predetermined air blowing time (Sα, S311 to S313). After the execution of the air blowing operation, the operation of the image forming portion 201B is resumed (S305), and the feeding operation is resumed (S306). Thereafter, every time a predetermined number of sheets S are fed from the end of the previous air blowing operation, the operation and the feeding operation of the image forming portion 201B are stopped, and after the air blowing operation is performed, the operation and the feeding operation of the image forming portion 201B are resumed.

As described above, in Example 1, the rotation of the photosensitive drums 212 are stopped if the air blowing operation is executed. In other words, in Example 1, if the air blowing operation is performed, the rotational speeds of the photosensitive drums 212 are reduced to 0 mm/sec. As a result, even in a case where the air blowing operation is executed, increase in the cumulative rotation amount of the photosensitive drums 212 with respect to the cumulative number of printed sheets of the image forming apparatus 200 is suppressed compared to the case where the photosensitive drums 212 are continuously rotationally driven at the process speed. Therefore, wear of the photosensitive drums 212 due to rubbing with the cleaning blade 231 or the like can be reduced. That is, according to this example, it is possible to provide an image forming apparatus configured to suppress a decrease in the number of printable sheets of the photosensitive member.

As will be described in Example 2 described later, if the air blowing operation is executed, even if the rotation of the photosensitive drums 212 is changed to a predetermined speed (second speed) lower than the process speed (first speed) without stopping the rotation, similar advantages can be obtained. In other words, when executing the adjustment operation, the control portion executes a mode of stopping rotation of the photosensitive member or changing a rotational speed of the photosensitive member from a first speed, which is a rotational speed of the photosensitive member in a case where the image forming portion forms an image on a sheet, to a second speed lower than the first speed. As a result, it is possible to provide an image forming apparatus configured to suppress a decrease in the number of printable sheets of the photosensitive member.

In Example 1, the application of the charging voltage is stopped if the air blowing operation is executed. In other words, in Example 1, if the air blowing operation is performed, the voltage applied to the charger 213 by the charging power supply 600 is lowered to 0V. As a result, even in a case where the air blowing operation is executed, an increase in the cumulative time during which the charging voltage is applied to the charger 213 is reduced with respect to the cumulative number of printed sheets of the image forming apparatus 200, compared to a case where the charger 213 is continuously applied with the charging voltage having the same voltage value as that at the time of image formation. As a result, it is possible to suppress deterioration of the surfaces of the photosensitive drums 212 due to discharge, and it is possible to suppress acceleration of wear of the photosensitive drums 212 due to deterioration of the surfaces. That is, according to this example, it is possible to provide an image forming apparatus configured to suppress a decrease in the number of printable sheets of the photosensitive member.

As described in Example 3 described later, if the air blowing operation is executed, even if the application of the charging voltage is not stopped and the charging voltage is changed to a predetermined voltage value (second voltage value) lower than the value (first voltage value) of the charging voltage at the time of image formation, the same advantage can be obtained. In other words, if the adjustment operation is performed, the control portion performs a mode of changing the voltage applied to the charging unit by the voltage application unit from a first voltage value, which is a value of the voltage applied to the charging unit by the voltage application unit in a case where the image forming portion forms an image on a sheet, to a second voltage value lower than the first voltage value. As a result, it is possible to provide an image forming apparatus configured to suppress a decrease in the number of printable sheets of the photosensitive member.

In Example 1, if the air blowing operation is executed, the rotation of the photosensitive drums 212 is stopped, and the application of the charging voltage is stopped. As a result, it is possible to provide an image forming apparatus configured to further suppress a decrease in the number of printable sheets of the photosensitive member.

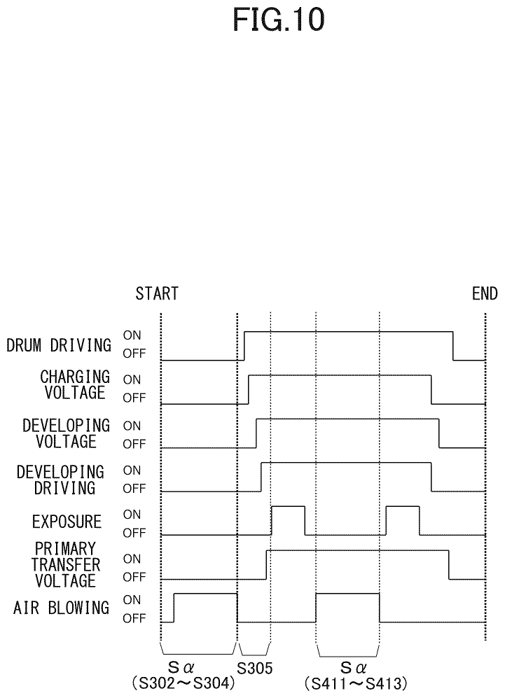

Next, the operation state of the image forming portion 201B in a case where the air blowing time is short will be described with reference to the sequence chart of FIG. 10 while referring to the flows of FIGS. 7 and 9. The operation from the start of the print job (S301) to the feeding of the predetermined number of sheets S is the same as the sequence chart of FIG. 8 except that the air blowing time is different.

If the predetermined number of sheets S is fed from the start of the print job, the air blowing operation is executed at a predetermined air blowing time (Sα, S411 to S413). Unlike the case where the air blowing time is long (FIG. 8), the air blowing operation is executed in a state where the operation of the image forming portion 201B is not stopped.

Then, after the air blowing operation is executed, the feeding operation (S306) is resumed. Further, the exposure by the exposing unit 210 is resumed, and an image is formed on each fed sheet S. Thereafter, every time a predetermined number of sheets S are fed from the previous air blowing operation, the feeding operation is stopped, and the feeding operation is resumed after the air blowing operation is performed.

As described above, in this example, if the air blowing time is short, the air blowing operation is executed without stopping the operation of the image forming portion 201B. As a result, it is possible to reduce the influence of stopping the operation of the image forming portion 201B if the merit of stopping the operation of the image forming portion 201B is small. Since the cleaning blades 231 rub against the respective photosensitive drums 212 to mechanically scrape off the adhered substance, if the frictional force between the cleaning blades and the photosensitive drums 212 increases and the cleaning blades 231 turn, the function of removing the toner is impaired. Therefore, if the air blowing time is short, a process of forming a toner image for supply on the photosensitive drums 212 at the timing of executing the air blowing operation without stopping the operation of the image forming portion 201B, and supplying the toner as the lubricant to the cleaning blades 231 may be performed in parallel. Accordingly, the turning-up of the cleaning blades 231 can be suppressed. Relationship Between Length of Air Blowing Time and Stop of Image Forming Portion

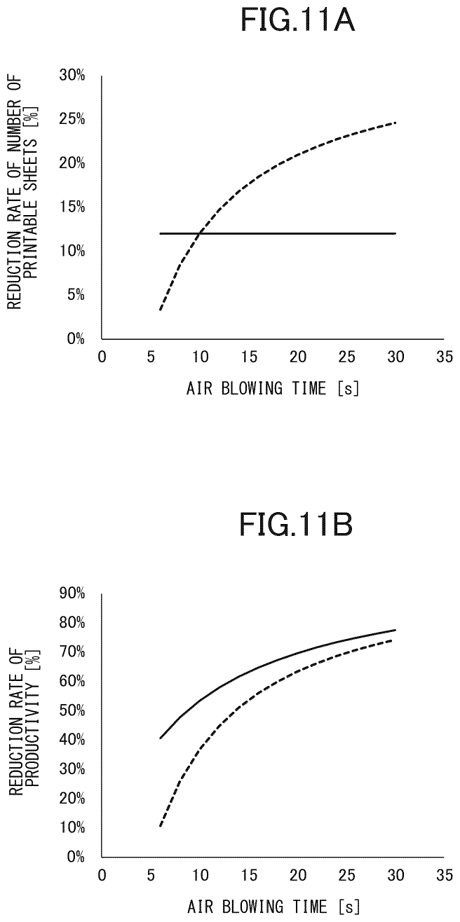

A detailed reason for executing the air blowing operation without stopping the operation of the image forming portion 201B in a case where the air blowing time is short, and a reference of the air blowing time as to whether or not to stop the operation of the image forming portion 201B will be described with reference to FIGS. 11A and 11B.

FIG. 11A is a graph illustrating a relationship between the length of an air blowing time (horizontal axis) and a reduction rate (vertical axis) of the number of printable sheets of the photosensitive drums 212. FIG. 11B is a graph illustrating the relationship between the length of the air blowing time (horizontal axis) and the reduction rate of the productivity of the image forming apparatus 200 (vertical axis). The horizontal axis in each drawing represents the time length of one air blowing operation. The vertical axis in FIG. 11A represents a reduction width of the printable number of sheets of the photosensitive drums 212 in a case where the air blowing operation is executed with the printable number of sheets of the photosensitive drums 212 in a case where the air blowing operation is not executed as a reference (100%). The “printable number of sheets of the photosensitive drums 212” represents the cumulative number of printed sheets that can output an image without causing an image defect due to wear of the photosensitive drums 212 in a case where an endurance test is executed in which an image forming operation of forming a predetermined test image on the sheet S is repeatedly executed from a state where the photosensitive drums 212 are new. The vertical axis in FIG. 11B represents the reduction width of the productivity in a case where the air blowing operation is executed with the productivity (the number of printed sheets per unit time in the continuous print job) of the image forming apparatus 200 in a case where the air blowing operation is not executed as a reference (100%).

FIGS. 11A and 11B are based on a result of executing a print job in which coated paper is used as the sheet S, an air blowing operation is executed once every time 10 coated papers are fed, and an image is formed on 500 coated papers in total. Solid lines in FIGS. 11A and 11B represent a result in a case where the operation of the image forming portion 201B is stopped at the time of executing the air blowing operation, and broken lines represent a result in a case where the operation of the image forming portion 201B is not stopped at the time of executing the air blowing operation.

As indicated by broken lines in FIGS. 11A and 11B, if the operation of the image forming portion 201B is not stopped at the time of executing the air blowing operation, as the air blowing time becomes longer, both the number of printable sheets and the reduction rate of the productivity become larger. The reason why the reduction rate of the printable number of sheets increases according to the length of the air blowing time is that the wear amount of the photosensitive drums 212 with respect to the cumulative number of printed sheets increases as the period during which the image forming portion 201B is driven becomes long although the toner image is not created as described above. The reason why the reduction rate in productivity increases according to the length of the air blowing time is that the feeding operation is stopped if the air blowing operation is executed, and thus the feeding interval (sheet interval) of the sheet becomes longer compared to the case where the feeding operation is repeated without executing the air blowing operation.

As indicated by a solid line in FIG. 11A, if the operation of the image forming portion 201B is stopped at the time of executing the air blowing operation, the reduction rate of the printable number of sheets becomes substantially constant regardless of the length of the air blowing time. This is because, since the rotation of the photosensitive drums 212 is stopped at the time of executing the air blowing operation, even if the air blowing time becomes long, the period during which the image forming portion 201B is driven does not become long although the toner image is not created. On the other hand, the number of printable sheets is reduced compared to a case where the air blowing operation is not executed, because a period in which the photosensitive drums 212 are rotationally driven although the toner image is not created occurs as the air blowing operation is executed. That is, if the operation of the image forming portion 201B is stopped before the start of the air blowing operation and if the operation of the image forming portion 201B is resumed after the end of the air blowing operation, there is a period in which the photosensitive drums 212 are rotationally driven although the toner image is not created.

In FIG. 11A, if the region where the air blowing time is 10 seconds or more is viewed, it can be seen that the case (solid line) where the operation of the image forming portion 201B is stopped at the time of executing the air blowing operation is more advantageous. That is, if the air blowing time is 10 seconds or more, the reduction rate of the printable number of sheets on the photosensitive drums 212 is lower in the case where the operation of the image forming portion 201B is stopped at the time of executing the air blowing operation (solid line) than in the case where the operation of the image forming portion 201B is not stopped (broken line). This means that if the air blowing time is long, the rotation amount of each photosensitive drum 212 during the execution of the air blowing operation exceeds the increase in the rotation amount of each photosensitive drum 212 accompanying the operation stop and the operation restart of the image forming portion 201B.

On the other hand, if the air blowing time is less than 10 seconds, the reduction rate of the printable number of sheets on the photosensitive drums 212 is more significant in the case where the operation of the image forming portion 201B is stopped at the time of executing the air blowing operation (solid line) than in the case where the operation of the image forming portion 201B is not stopped (broken line). This means that, if the air blowing time is short, the rotation amount of each photosensitive drums 212 during the execution of the air blowing operation falls below the increase in the rotation amount of each photosensitive drum 212 accompanying the operation stop and the operation restart of the image forming portion 201B.

As illustrated in FIG. 11B, regardless of the length of the air blowing time, the productivity (solid line) in a case where the operation of the image forming portion 201B is stopped at the time of executing the air blowing operation is lower than the productivity (broken line) in a case where the operation of the image forming portion 201B is not stopped at the time of executing the air blowing operation. However, the ratio (X/Y) between the reduction rate X of the productivity indicated by the solid line and the reduction rate Y of the productivity indicated by the broken line becomes more remarkable as the air blowing time is shorter. This is because a period for stopping and restarting the operation of the image forming portion 201B is required before the start and after the end of the air blowing operation. In addition, as the air blowing time is shorter, the ratio of the period of stopping and restarting the operation of the image forming portion 201B in the period from the stop of the feeding operation to the restart of the feeding operation after the execution of the air blowing operation increases.

From the above results, if the air blowing time is long, it is preferable to stop the operation of the image forming portion 201B at the time of executing the air blowing operation from the viewpoint of suppressing the decrease in the printable number of sheets of the photosensitive drums 212. In addition, if the air blowing time is long, even if the operation of the image forming portion 201B is stopped at the time of executing the air blowing operation, the influence on the decrease in productivity of the image forming apparatus 200 is relatively small.

On the other hand, if the air blowing time is short, from the viewpoint of suppressing a decrease in the number of printable sheets of the photosensitive drums 212 and a decrease in productivity of the image forming apparatus 200, it is preferable not to stop the operation of the image forming portion 201B at the time of executing the air blowing operation.

Therefore, in Example 1, if the air blowing time is less than 10 seconds, the operation of the image forming portion 201B is not stopped at the time of executing the air blowing operation, and if the air blowing time is 10 seconds or more, the operation of the image forming portion 201B is stopped at the time of executing the air blowing operation. As a result, in a configuration in which the length of the air blowing time can be changed according to environmental conditions and the like, the number of printable sheets and productivity can be realized at a high level.

Note that the threshold of the air blowing time as to whether or not to stop the operation of the image forming portion 201B at the time of executing the air blowing operation is not limited to the above value (10 seconds). Further, in this example, the configuration in which the air blowing time is changed on the basis of the temperature and humidity information as an example of the environmental conditions has been exemplified, but the above-described control can also be applied to a case where the air blowing time is changed according to other conditions (for example, the material and size of the sheet S).

As described above, in Example 1, whether or not to stop or decelerate the rotation of the photosensitive drums 212 at the time of executing the air blowing operation is changed according to the length of the air blowing time. In other words, the mode is a first mode, and the control portion executes the first mode where the time length of the adjustment operation is a first length, and executes a second mode in which the rotational speed of the photosensitive member is maintained at the first speed where the adjustment operation is executed if the time length of the adjustment operation is a second length shorter than the first length. The case where the time length of the adjustment operation is the first length is, for example, a case where the air blowing time is 30 seconds. The case where the time length of the adjustment operation is the second length is, for example, a case where the air blowing time is 5 seconds. Accordingly, the printable number of sheets and the productivity can be realized at a high level.

In Example 1, whether to stop the application of the charging voltage or decrease the voltage value at the time of executing the air blowing operation is changed according to the length of the air blowing time. In other words, the mode is a first mode, and if the time length of the adjustment operation is a first length, the control portion executes the first mode when executing the adjustment operation, and if the time length of the adjustment operation is a second length shorter than the first length, the control portion executes a second mode in which the voltage applied by the voltage application unit to the charging unit is maintained at the first voltage value when executing the adjustment operation. Accordingly, the printable number of sheets and the productivity can be realized at a high level.

### Modification

Note that, in Example 1, the method of stopping the rotation of the photosensitive drums 212 and stopping the application of the charging voltage at the time of executing the air blowing operation has been described, but only one of the rotation stop of the photosensitive drums 212 and the application stop of the charging voltage may be performed. As a result, wear of the photosensitive drums 212 can be reduced at least compared to a configuration in which the photosensitive drums 212 are continuously rotated at a process speed even during the execution of the air blowing operation, and a charging voltage having the same voltage value as that at the time of image formation is applied.

If the application of the charging voltage is continued in a state in which the photosensitive drums 212 are stopped, the surfaces of the photosensitive drums 212 are locally deteriorated by continuing to receive the discharge of the charger 213, which may cause an image defect. Therefore, in order to obtain an image with better image quality, if the application of the charging voltage is not stopped at the time of executing the air blowing operation, it is preferable to stop the rotation of the photosensitive drums 212 or to decelerate the rotation of the photosensitive drums 212 as in Example 2.

### Example 2

An image forming apparatus according to Example 2 will be described. In Example 1, the method of stopping the rotation of the photosensitive drums 212 when executing the air blowing operation has been described, but in Example 2, the rotation of the photosensitive drums 212 is decelerated without being stopped when executing the air blowing operation. Hereinafter, elements denoted by reference numerals common to those in Example 1 are assumed to have basically the same configurations and operations as those described in Example 1 unless otherwise specified, and portions different from those in Example 1 will be mainly described.

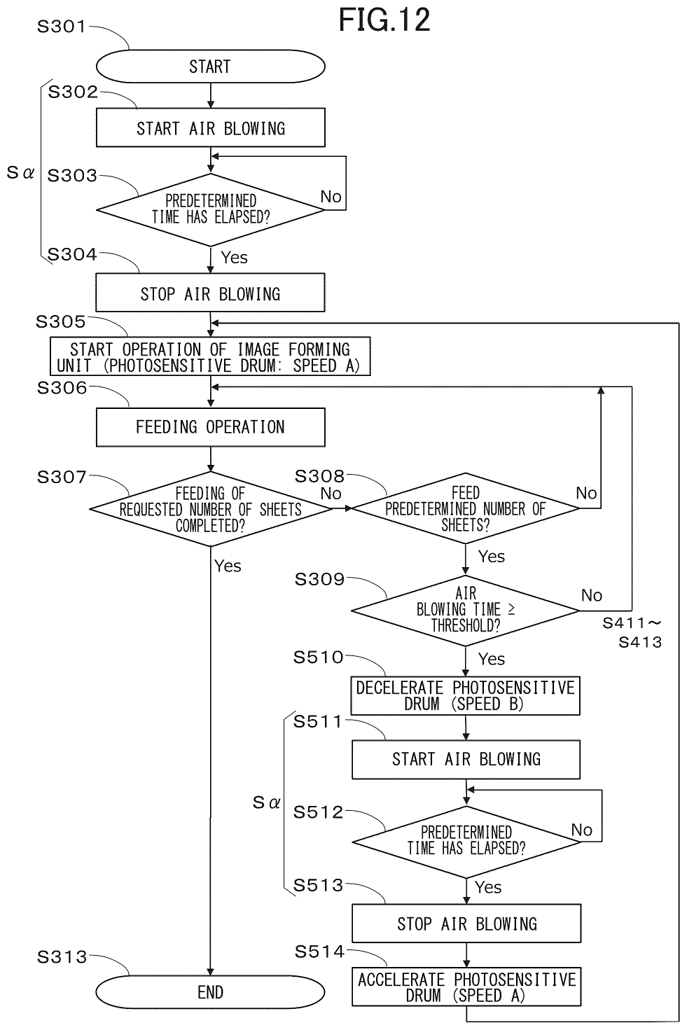

A print job control method in Example 2 will be described with reference to FIG. 12. Since the contents of S301 to S309, S314, and S411 to S413 in FIG. 12 are the same as those in Example 1 (FIGS. 7 and 9), the description thereof will be omitted.

Similarly to Example 1, while repeatedly executing the feeding operation (S306), the control portion 100 temporarily stops the feeding operation and executes the air blowing operation(S) every time the number of fed sheets after the start of the job increases by a predetermined number. That is, before the number of fed sheets after the start of the job reaches the requested number of sheets of the print job (No in S307), the control portion 100 executes the air blowing operation if the number of fed sheets after the start of the job has increased by a predetermined number from the end of the previous air blowing operation (Yes in S308).

In a case where the air blowing operation is executed in the middle of the print job, if the air blowing time is long (Yes in S309), the procedures of S510 to S514 in FIG. 12 are executed. Specifically, if the value of the air blowing time is greater than or equal to a predetermined threshold, it is determined that the air blowing time is long. The threshold is, for example, 10 seconds.

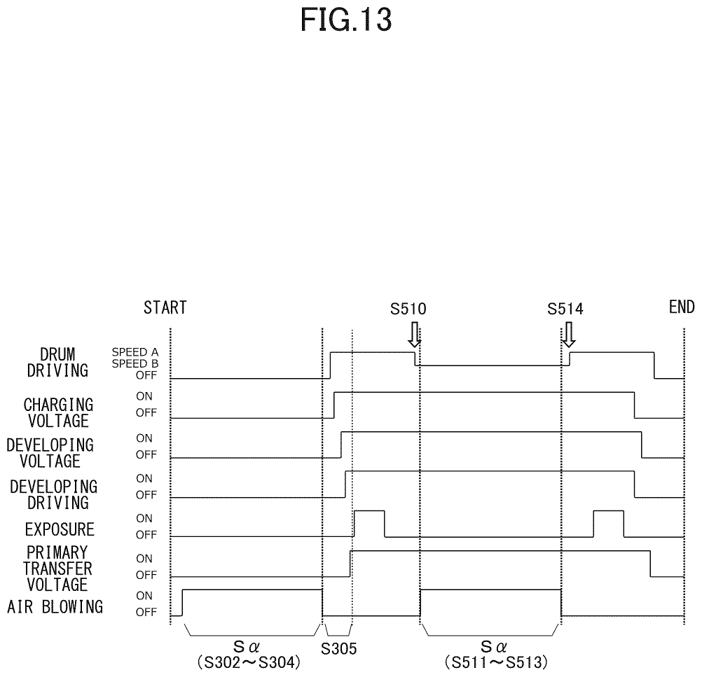

In a case where the air blowing operation is executed in the middle of the print job, if the air blowing time is long, the rotational speed of the photosensitive drums 212 is decelerated to a predetermined speed (described as “speed B”) lower than the process speed (It is described as “speed A” in FIGS. 12 and 13). In other words, when executing the adjustment operation, the control portion executes a mode of stopping rotation of the photosensitive member or changing a rotational speed of the photosensitive member from a first speed that is a rotational speed of the photosensitive member in a case where the image forming portion forms an image on a sheet to a second speed slower than the first speed. After the rotational speed of the photosensitive drums 212 is reduced to the speed B, the air blowing operation (Sα, S511 to S513) is executed. After the air blowing operation is finished, the rotational speed of the photosensitive drums 212 is re-accelerated to the process speed.

Specifically, in the case of Yes in S309, the control portion 100 sends a command to the drum driving motor 610 to change the rotational speed (circumferential speed) of the photosensitive drums 212 from the process speed (speed A) to a predetermined speed (speed B) lower than the process speed (S510). It is assumed that the values of the process speed (the speed A and the predetermined speed (the speed B) are determined in advance and stored in the storage unit (for example, the ROM 102 in FIG. 2) of the control portion 100. In the extension feeder 500, the driving of the fans 511b and 512b of the air blowing portions 511A and 512A is started based on the command from the control portion 100 (S511), so that the air blowing operation is started. If a predetermined time (air blowing time) has elapsed from the start of driving of the fans 511b and 512b (Yes in S512), the driving of the fans 511b and 512b is stopped (S513), and the air blowing operation is terminated.

If the air blowing operation is finished, the control portion 100 sends a command to the drum driving motor 610 to change the rotational speed of the photosensitive drums 212 from the predetermined speed (speed B) to the process speed (speed A) (S514). After the rotational speed of the photosensitive drums 212 is stabilized at the process speed (speed A), the control portion 100 restarts the feeding operation (S306).

An operation state of the image forming portion 201B in a case where the air blowing time is long in Example 2 will be described with reference to the sequence chart of FIG. 13 with reference to the flow of FIG. 12. The operation from the start of the print job (S301) to the feeding of the predetermined number of sheets S is the same as that in the sequence chart of FIG. 8.

If the predetermined number of sheets S counted from the start of the print job is fed, the photosensitive drums 212 are decelerated from the process speed (speed A) to the predetermined speed (speed B) in order to execute the air blowing operation (S510). Then, in a state where the photosensitive drums 212 are rotationally driven at a predetermined speed (speed B), the air blowing operation is executed at a predetermined air blowing time (Sα, S511 to S513). After the air blowing operation is performed, the photosensitive drums 212 are accelerated from the predetermined speed (speed B) to the process speed (speed A) (S514). Further, the driving of the feeding motor 520 is started, and the feeding operation is resumed (S306). Thereafter, every time a predetermined number of sheets S are fed from the end of the previous air blowing operation, the rotational speed of the photosensitive drums 212 are decelerated to a predetermined speed, and after the air blowing operation is performed, the rotational speed of the photosensitive drums 212 are accelerated to the process speed.

As described above, in Example 2, if the air blowing operation is executed, the rotation of the photosensitive drums 212 is decelerated to a predetermined speed lower than the process speed. As a result, even in a case where the air blowing operation is executed, an increase in the cumulative rotation amounts of the photosensitive drums 212 with respect to the cumulative number of printed sheets of the image forming apparatus 200 is suppressed compared to the case where the photosensitive drums 212 are continuously rotationally driven at the process speed. Therefore, wear of the photosensitive drums 212 due to rubbing with the cleaning blades 231 or the like can be reduced. That is, according to this example, it is possible to provide an image forming apparatus configured to suppress a decrease in the number of printable sheets of the photosensitive member.

In Example 2, the voltage outputs of the various high-voltage power supplies are not stopped (OFF) when executing the air blowing operation. Therefore, compared to Example 1, the downtime of the image forming apparatus 200 associated with the execution of the air blowing operation can be shortened, and the productivity of the image forming apparatus 200 can be improved.

### Modification

In Example 2, if the air blowing operation is executed, the application of the charging voltage to the charger 213 may be stopped (OFF). As a result, it is possible to suppress the deterioration of the surfaces of the photosensitive drums 212 due to the discharge of the charger 213 during the execution of the air blowing operation, and it is possible to suppress the acceleration of the wear of the photosensitive drums 212 due to the deterioration of the surfaces. That is, according to the present modification, it is possible to provide an image forming apparatus configured to further suppress an increase in the wear amount of the photosensitive member compared to Example 2.

### Example 3

An image forming apparatus according to Example 3 will be described. In Example 1, the method of stopping the application of the charging voltage to the charger 213 when executing the air blowing operation has been described, but in Example 3, the voltage value is lowered without stopping the application of the charging voltage when executing the air blowing operation. Hereinafter, elements denoted by reference numerals common to those in Example 1 are assumed to have basically the same configurations and operations as those described in Example 1 unless otherwise specified, and portions different from those in Example 1 will be mainly described.

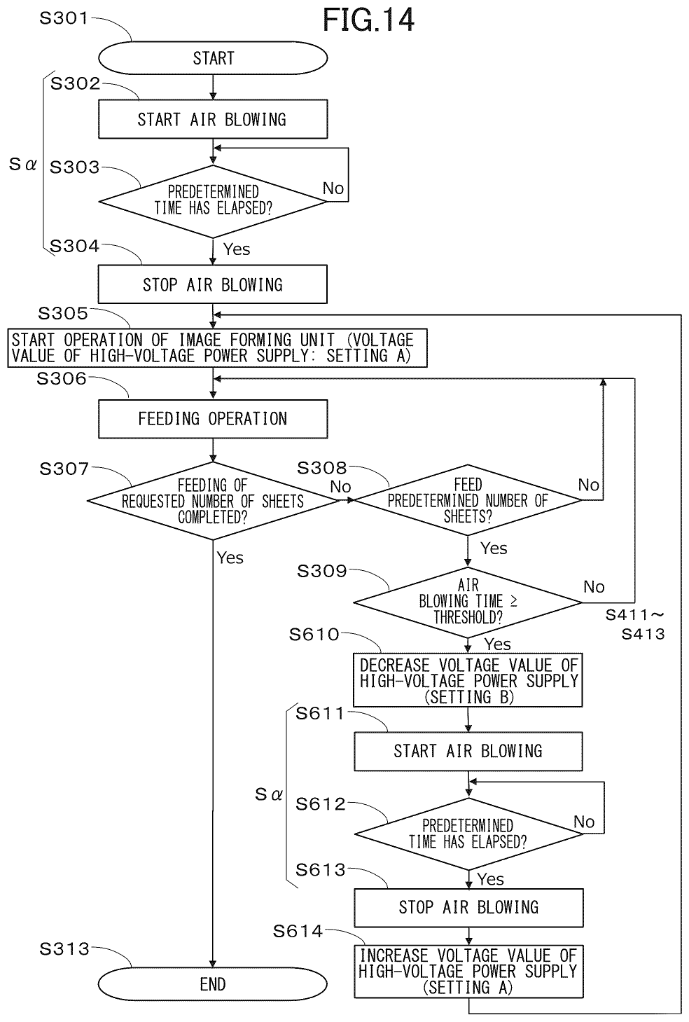

A print job control method in Example 3 will be described with reference to FIG. 14. Since the contents of S301 to S309, S314, and S411 to S413 in FIG. 14 are the same as those in Example 1 (FIGS. 7 and 9), the description thereof will be omitted.

Similarly to Example 1, while repeatedly executing the feeding operation (S306), the control portion 100 temporarily stops the feeding operation and executes the air blowing operation (Sα) every time the number of fed sheets after the start of the job increases by a predetermined number. That is, before the number of fed sheets after the start of the job reaches the requested number of sheets of the print job (No in S307), the control portion 100 executes the air blowing operation if the number of fed sheets after the start of the job has increased by a predetermined number from the end of the previous air blowing operation (Yes in S308).

In a case where the air blowing operation is executed in the middle of the print job, if the air blowing time is long (Yes in S309), the procedures of S610 to S614 in FIG. 14 are executed. Specifically, if the value of the air blowing time is greater than or equal to a predetermined threshold, it is determined that the air blowing time is long. The threshold is, for example, 10 seconds.

In a case where the air blowing operation is executed in the middle of the print job, if the air blowing time is long, the output voltages of the various high-voltage power supplies are set to predetermined voltage values lower than voltage values (hereinafter, referred to as “setting A”) in a case where the image forming operation is executed. Hereinafter, a predetermined voltage value lower than the voltage value (setting A) at the time of executing the image forming operation is referred to as “setting B”. In other words, if the adjustment operation is performed, the control portion performs a mode of changing the voltage applied to the charging unit by the voltage application unit from a first voltage value, which is a value of the voltage applied to the charging unit by the voltage application unit in a case where the image forming portion forms an image on a sheet, to a second voltage value lower than the first voltage value. After the output voltages of the various high-voltage power supplies are lowered to a predetermined voltage value (setting B), an air blowing operation (Sα, S611 to S613) is executed. After the air blowing operation is finished, the output voltages of the various high-voltage power supplies are increased to voltage values (setting A) at the time of executing the image forming operation.

Specifically, in the case of Yes in S309, the control portion 100 changes the output voltages of the various high-voltage power supplies from the voltage value (setting A) at the time of executing the image forming operation to a predetermined voltage value (setting B) (S610). As a result, the output voltages (charging voltage, developing voltage, and primary transfer voltage) of the charging power supply 600, the developing power supply 601, and the primary transfer power supply 602 each drop to a predetermined voltage value (setting B). It is assumed that the voltage value (setting A) and the predetermined voltage value (setting B) at the time of executing the image forming operation are determined in advance and stored in the storage unit (for example, the ROM 102 in FIG. 2) of the control portion 100. Note that the values (setting A) of the charging voltage, the developing voltage, and the primary transfer voltage when executing the image forming operation may be different from each other. In addition, the values (setting B) of the charging voltage, the developing voltage, and the primary transfer voltage when executing the air blowing operation may be different from each other.

In the extension feeder 500, the driving of the fans 511b and 512b of the air blowing portions 511A and 512A is started based on the command from the control portion 100 (S611), so that the air blowing operation is started. If a predetermined time (air blowing time) has elapsed from the start of driving of the fans 511b and 512b (Yes in S612), the driving of the fans 511b and 512b is stopped (S613), and the air blowing operation is terminated.

If the air blowing operation is ended, the control portion 100 changes the output voltages of the various high-voltage power supplies from the predetermined voltage value (setting B) to the voltage value (setting A) in a case where the image forming operation is executed. As a result, the charging voltage, the developing voltage, and the primary transfer voltage each rise to a voltage value (setting A) at the time of executing the image forming operation (S614). After the charging voltage, the developing voltage, and the primary transfer voltage are stabilized at the voltage value (setting A) at the time of executing the image forming operation, the control portion 100 restarts the feeding operation (S306).

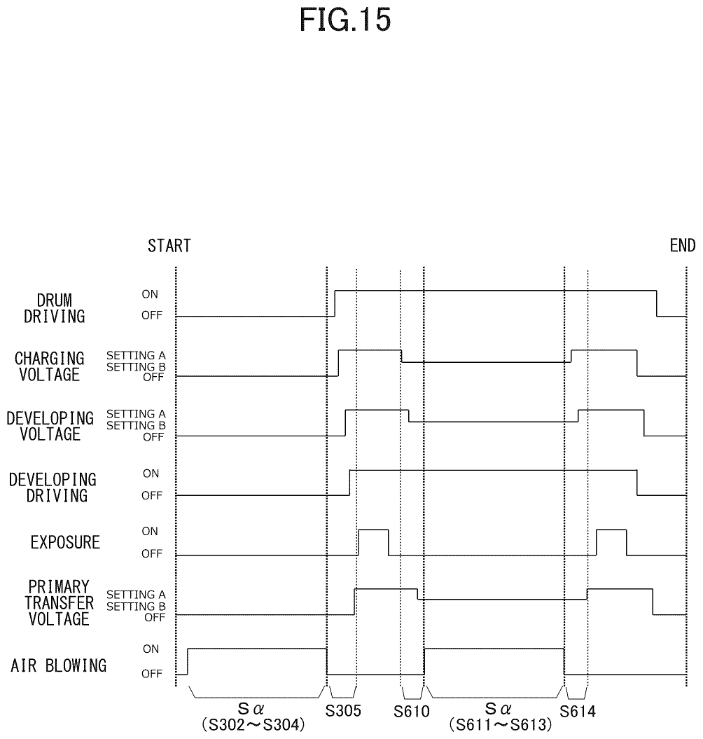

In Example 3, the operation state of the image forming portion 201B in a case where the air blowing time is long will be described with reference to the sequence chart of FIG. 15 with reference to the flow of FIG. 14. The operation from the start of the print job (S301) to the feeding of the predetermined number of sheets S is the same as that in the sequence chart of FIG. 8.

If the predetermined number of sheets S from the start of the print job are fed, the output voltages (charging voltage, developing voltage, and primary transfer voltage) of the various high-voltage power supplies are lowered from the voltage value (setting A) at the time of executing the image forming operation to a predetermined voltage value (setting B) (S610). Then, in a state where the output voltages of the various high-voltage power supplies are lowered to a predetermined voltage value (setting B), the air blowing operation is executed for a predetermined air blowing time (Sα, S611 to S613). After the air blowing operation is executed, the output voltages of the various high-voltage power supplies are raised to voltage values (setting A) if the image forming operation is executed again (S614). Further, the driving of the feeding motor 520 is started, and the feeding operation is resumed (S306). Thereafter, every time a predetermined number of sheets S are fed from the previous air blowing operation, the output voltages of the various high-voltage power supplies are lowered to a predetermined voltage value (setting B), and after the air blowing operation is performed, the output voltages of the various high-voltage power supplies are raised to the original voltage value (setting A).

As described above, in Example 3, if the air blowing operation is executed, the voltage value of the charging voltage applied to the charger 213 is reduced compared to the voltage value at the time of image formation. As a result, compared to a case where the charger 213 continuously applies a charging voltage having the same voltage value as that at the time of image formation even in a case where the air blowing operation is executed, an increase in the cumulative time in which the charging voltage at the time of image formation is applied to the charger 213 with respect to the cumulative number of printed sheets of the image forming apparatus is suppressed. As a result, it is possible to suppress deterioration of the surfaces of the photosensitive drums 212 due to discharge, and it is possible to suppress acceleration of wear of the photosensitive drums 212 due to deterioration of the surfaces. That is, according to this example, it is possible to provide an image forming apparatus configured to suppress a decrease in the number of printable sheets of the photosensitive member.

In Example 3, in a case where the air blowing operation is executed, the rotation of the photosensitive drums 212 is not stopped or decelerated. Therefore, compared to Example 1, the downtime of the image forming apparatus 200 associated with the execution of the air blowing operation can be shortened, and the productivity of the image forming apparatus 200 can be improved. Modification

In Example 3, in a case where the air blowing operation is executed, the rotation of the photosensitive drums 212 may be stopped, or the rotational speed of the photosensitive drums 212 may be decelerated. As a result, it is possible to reduce the rotation amounts of the photosensitive drums 212 while executing the air blowing operation. That is, according to the present modification, it is possible to provide an image forming apparatus configured to further suppress an increase in the wear amount of the photosensitive member compared to Example 3.

### Other Modifications

In each of the above-described embodiments, the image forming apparatus 200 configured to execute the air blowing operation has been described as an example of the “adjustment operation,” but the “adjustment operation” may be another operation. For example, in an image forming apparatus including a plurality of sheet feeding portions, the “adjustment operation” may be an operation of automatically switching the supply source of the sheet to another sheet feeding portion in a case where the sheet is exhausted in the sheet feeding portion being used during the execution of the print job. In this case, the rotation of the photosensitive drums 212 may be stopped, or the charging voltage may be stopped, for example, in a waiting time until preparation for feeding is completed in the sheet feeding portion to which the supply source has been switched. In this case, the predetermined number of sheets is the number of sheets stacked on the sheet feeding portion to be used first. Furthermore, the “adjustment operation” may be, for example, a cooling period set to avoid overheating of each roller of the feeding unit and the feeding motor.

In each of the above-described embodiments, the configuration in which the air blowing portions 511A and 512A as the air loosening mechanism are provided in the extension feeder 500 has been exemplified. The air loosening mechanism is not limited to the extension feeder 500, and it may be provided in another sheet feeding module (for example, the manual feeding portion 235 or the cassette feeding portion 230 in the image forming apparatus 200 of FIG. 1) included in the image forming apparatus. In this case, the control described in each embodiment may be applied if the feeding operation is stopped and the air blowing operation is executed during the execution of the print job in which the sheet S is fed from the manual feeding portion 235 or the cassette feeding portion 230 provided with the air loosening mechanism.

In each of the above-described embodiments, the configuration in which the mode (first mode) in which the photosensitive drums 212 are stopped or the like in a case where the air blowing operation is executed and the mode (second mode) in which the photosensitive drums 212 are not stopped or the like in a case where the air blowing operation is executed are selectively executed according to the length of the air blowing time has been described. Not limited to this, for example, in a case where the air blowing operation is performed with the length of the air blowing time fixed, the operation may be performed in a mode in which the photosensitive drums 212 are stopped in a case where the air blowing operation is performed.

In each of the above-described embodiments, the image forming portion 201B, which is an intermediate transfer-tandem type electrophotographic mechanism, has been exemplified as the image forming portion. The image forming portion is not limited thereto, and it may be, for example, a direct transfer type in which a toner image formed on a photosensitive member is directly transferred to the sheet S without passing through an intermediate transfer member. The image forming portion may include only one photosensitive member and form a monochrome image using one type of toner.

### Other Embodiments

The present invention can also be realized by processing in which a program for realizing one or more functions of the above-described embodiments is supplied to a system or an apparatus via a network or a storage medium, and one or more processors in a computer of the system or the apparatus read and execute the program. The present invention can also be implemented by a circuit (for example, ASIC) that implements one or more functions.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-167839, filed on Sep. 28, 2023, which is hereby incorporated by reference herein in its entirety.

What is claimed is:

1. An image forming apparatus configured to form an image on a sheet, comprising:
an image forming portion including a rotatable image bearing member, a charging unit configured to charge the image bearing member, an exposing unit configured to expose the image bearing member charged by the charging unit to form an electrostatic latent image on the image bearing member, and a developing unit configured to develop the electrostatic latent image formed on the image bearing member using developer,
a driving portion configured to rotationally drive the image bearing member;
a sheet support portion configured to support the sheet;
a sheet blowing portion configured to perform a blowing operation of blowing air to the sheet supported on the sheet support portion;
a sheet feeding portion configured to perform a feeding operation of feeding the sheet supported on the sheet support portion; and
a control portion configured to execute a mode in which, in a predetermined period after the sheet fed by the sheet feeding portion passes through a transfer position at which a toner image formed by the image forming portion is transferred to the sheet and before a succeeding sheet fed by the sheet feeding portion passes through the transfer position, the blowing operation is performed in a state where the feeding operation is stopped, wherein
the control portion is configured to control the driving portion to stop rotation of the image bearing member during the mode.

2. The image forming apparatus according to claim 1, wherein
the control portion is configured to control the driving portion to stop the rotation of the image bearing member during the mode, in a case where a time for which the sheet blowing portion performs the blowing operation in the predetermined period is equal to or longer than a predetermined time.

3. The image forming apparatus according to claim 2, wherein
the control portion is configured to execute the mode without stopping the rotation of the image bearing member during the mode, in a case where the time for which the sheet blowing portion performs the blowing operation in the predetermined period is less than the predetermined time.

4. The image forming apparatus according to claim 1, wherein
the control portion is configured to execute the mode without stopping the rotation of the image bearing member during the mode, in a case where a time for which the sheet blowing portion performs the blowing operation in the predetermined period is less than a predetermined time.

5. The image forming apparatus according to claim 1, further comprising:
a detection portion configured to detect environmental humidity, wherein
the sheet blowing portion is configured to (i) perform the blowing operation for a first time in the predetermined period in a case where the environmental humidity detected by the detection portion is a first humidity and (ii) perform the blowing operation for a second time longer than the first time in the predetermined period in a case where the environmental humidity detected by the detection portion is a second humidity higher than the first humidity.

6. The image forming apparatus according to claim 1, wherein
the sheet blowing portion is configured to perform the blowing operation in the predetermined period, in a case where the sheet supported on the sheet support portion is a predetermined sheet.

7. The image forming apparatus according to claim 1, further comprising:
an image forming apparatus body including the image forming portion, wherein
the sheet support portion is a manual feed tray provided on a side surface of the image forming apparatus body.

8. An image forming apparatus configured to form an image on a sheet, comprising:
an image forming portion including a rotatable image bearing member, a charging unit configured to charge the image bearing member, an exposing unit configured to expose the image bearing member charged by the charging unit to form an electrostatic latent image on the image bearing member, and a developing unit configured to develop the electrostatic latent image formed on the image bearing member using developer,
a driving portion configured to rotationally drive the image bearing member;
a sheet support portion configured to support the sheet;
a sheet blowing portion configured to perform a blowing operation of blowing air to the sheet supported on the sheet support portion;
a sheet feeding portion configured to perform a feeding operation of feeding the sheet supported on the sheet support portion; and
a control portion configured to execute a mode in which, in a predetermined period after the sheet fed by the sheet feeding portion passes through a transfer position at which a toner image formed by the image forming portion is transferred to the sheet and before a succeeding sheet fed by the sheet feeding portion passes through the transfer position, the blowing operation is performed in a state where the feeding operation is stopped, wherein
the control portion is configured to control the driving portion during the mode such that a rotational speed of the image bearing member during the mode is slower than a rotational speed of the image bearing member during a formation of the image on the sheet.

9. The image forming apparatus according to claim 8, wherein
the control portion is configured to control the driving portion such that the rotational speed of the image bearing member during the mode is slower than the rotational speed of the image bearing member during the formation of the image on the sheet, in a case where a time for which the sheet blowing portion performs the blowing operation in the predetermined period is a predetermined time or more.

10. The image forming apparatus according to claim 9, wherein
the control portion is configured to control the driving portion such that the rotational speed of the image bearing member during the mode is maintained at the rotational speed of the image bearing member during the formation of the image on the sheet, in a case where the time for which the sheet blowing portion performs the blowing operation in the predetermined period is less than the predetermined time.

11. The image forming apparatus according to claim 8, wherein
the control portion is configured to control the driving portion such that the rotational speed of the image bearing member during the mode is maintained at the rotational speed of the image bearing member during the formation of the image on the sheet, in a case where a time for which the sheet blowing portion performs the blowing operation in the predetermined period is less than a predetermined time.

12. The image forming apparatus according to claim 8, further comprising:
a voltage application unit configured to apply a voltage to the charging unit, wherein
a voltage value of a voltage applied to the charging unit by the voltage application unit during the mode is smaller than a voltage value of a voltage applied to the charging unit by the voltage application unit during the formation of the image on the sheet.

13. The image forming apparatus according to claim 8, further comprising:
a detection portion configured to detect environmental humidity, wherein
the sheet blowing portion is configured to (i) perform the blowing operation for a first time in the predetermined period in a case where the environmental humidity detected by the detection portion is a first humidity and (ii) perform the blowing operation for a second time longer than the first time in the predetermined period in a case where the environmental humidity detected by the detection portion is a second humidity higher than the first humidity.

14. The image forming apparatus according to claim 8, wherein
the sheet blowing portion is configured to perform the blowing operation in the predetermined period in a case where if the sheet supported on the sheet support portion is a predetermined sheet.

15. The image forming apparatus according to claim 8, further comprising:
an image forming apparatus body including the image forming portion, wherein the sheet support portion is a manual feed tray provided on a side surface of the image forming apparatus body.
